(19) United States
(12) Patent Application Publication
(10) Pub. No.: US 2011/0213697 A1
(43) Pub. Date: Sep. 1, 2011

(54) Financial Analysis Mechanisms

(75) Inventor: Kellie E. Dodini, Vacaville, CA (US)

(73) Assignee: Bank of America Corporation, Charlotte, NC (US)

(21) Appl. No.: 12/788,271

(22) Filed: May 26, 2010

Related U.S. Application Data
(60) Provisional application No. 61/308,517, filed on Feb. 26, 2010.

(51) Int. Cl. G06Q 40/00

(52) U.S. Cl. 705/38

(57) ABSTRACT

Aspects of the present disclosure provide a system for providing employees of a loan offering entity a tool that is more efficient and accurate than completing required multiple calculations manually by the employee. Still other aspects deliver a summary of the noted information that must be analyzed by the employee when determining qualifying income with accountability in place to ensure such noted information was analyzed, including checklists, confirmation notations, and/or other methods. Integrating a standard tool for tax analysis of evidentiary records of an individual drives a consistent approach to tax analysis to support salability requirements and fair lending. Guidance and support to accurately complete the tax analysis may be provided, and efficiency of the tax analysis process may be improved.

### RELATED APPLICATION

This application claims priority from U.S. Provisional Patent Application Ser. No. 61/308,517, filed Feb. 26, 2010, entitled, “Financial Analysis Mechanisms,” the contents of which are hereby incorporated by reference in its entirety.

### BACKGROUND

When assessing an individual to decide on the amount of funding by loans that the individual may be eligible for, an entity often creates a loan file for the individual based upon data associated with the entity, such as the current financial stability of the entity, e.g., policies in place for making loans, evidence received from the individual, such as a W-2 form from her employer, and possible other data parameters, such as current market trends that the entity may already include in its policies. Conventional methodologies for determining loan eligibility can be riddled with problems associated with fraud, inaccuracies, failure to complete all manual forms, the impact of varying income levels, and other issues.

Problems associated with income calculation and analysis errors, whether by an individual seeking a loan or an employee of an entity determining the amount of a loan, occur. In some cases, an employee of an entity determining the amount of a loan that an individual is eligible for fails to consistently complete the multiple calculations necessary to analyze, identify and address adverse income/employment trends or gaps. Variation in income analysis approaches and determining qualifying income is a problem as conventional methodologies lack standardization of processing and information. Still other problems include insufficient comments, entered by an employee of a potential loaning entity for justification, explaining how qualifying income was determined in addition to inconsistency of information in a file of a loan seeking individual showing how qualifying income was calculated and determined.

Many entity employees also are challenged with tax analysis for loan processing purpose due to varying degrees of experience and training. Most have learned “on the job” with limited resources and this has led to variation in how tax returns are analyzed. As such, two entity employees analyzing the same tax records may come up with highly different recommendations for a loan.

A tax tool is needed to help improve consistency, minimize human errors, provide some guidance to help to capture the right figures, and the ability to support multiple businesses. Existing manual form-based tax analysis can be difficult to read and understand how income was calculated.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure provide a system for providing employees of a loan offering entity a tool that is more efficient and accurate than completing required multiple calculations manually by the employee. Still other aspects deliver a summary of the noted information specific to credit policy requirements that must be analyzed by the employee when determining qualifying income with accountability in place to ensure such noted information was analyzed, including checklists, confirmation notations, and/or other methods.

Still other aspects of the present disclosure alert employees to adverse trends, gaps, and/or variations in income and employment information that warrant further review and explanation that may have been overlooked by the employee under a conventional system. By implementing one or more aspects of the present disclosure, consistent documentation for all loan files that will clearly show how income was calculated along with supporting comments by the analyzing employee of the loan offering entity may be produced.

Additional aspects reduce variation, across analyzing employees, in how income is calculated and improve adherence to policy through guidance and reinforcement of certain considerations. Still further aspects support income fraud detection and prevention. As income fraud is an ever increasing risk, aspects of the present disclosure help analyzing employees quickly and consistently validate paystub withholdings; thus providing quick reference to income red flags.

Still further aspects of the present disclosure improve quality and reduce errors which favorably impact salability, repurchases and delinquency. Integrating a standard tool for tax analysis of evidentiary records of an individual drives a consistent approach to tax analysis to support salability requirements and fair lending. Guidance and support to accurately complete the tax analysis may be provided, and efficiency of the tax analysis process may be improved.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an illustrative user interface for receiving and processing loan data and alerting individuals of a needed correction and/or issue associated with the loan data in accordance with one or more aspects of the present disclosure;

FIG. 4 is an illustrative user interface for receiving and processing loan data and alerting individuals of a needed correction and/or issue associated with the loan data in accordance with one or more aspects of the present disclosure;

FIG. 5 is a portion of the illustrative user interface of FIG. 3 for receiving and processing loan data and alerting individuals of a needed correction and/or issue associated with the loan data in a different state in accordance with one or more aspects of the present disclosure;

FIG. 6 is a portion of the illustrative user interface of FIG. 3 for receiving and processing loan data and alerting individuals of a needed correction and/or issue associated with the loan data in a different state in accordance with one or more aspects of the present disclosure;

FIG. 7 is a portion of the illustrative user interface of FIG. 3 and FIG. 4 for receiving and processing loan data and alerting individuals of a needed correction and/or issue associated with the loan data in a different state in accordance with one or more aspects of the present disclosure;

FIG. 8 is the illustrative user interface of FIG. 7 for receiving and processing loan data and alerting individuals of a needed correction and/or issue associated with the loan data in a corrected state in accordance with one or more aspects of the present disclosure;

FIG. 9 is a portion of the illustrative user interface of FIG. 4 for receiving and processing loan data and alerting individuals of a needed correction and/or issue associated with the loan data in a different state in accordance with one or more aspects of the present disclosure;

FIG. 10 is an illustrative user interface for receiving and processing withholdings data and alerting individuals of a needed correction and/or issue associated with the withholdings data in accordance with one or more aspects of the present disclosure;

FIG. 11 is an illustrative user interface for receiving and processing business expense data and alerting individuals of a needed correction and/or issue associated with the data in accordance with one or more aspects of the present disclosure;

FIG. 12 is an illustrative user interface for receiving and processing tax data and alerting individuals of a needed correction and/or issue associated with the tax data in accordance with one or more aspects of the present disclosure;

FIG. 13 is an illustrative user interface for receiving and processing tax data and alerting individuals of a needed correction and/or issue associated with the tax data in accordance with one or more aspects of the present disclosure;

FIG. 14 is an illustrative user interface for receiving and processing tax data and alerting individuals of a needed correction and/or issue associated with the tax data in accordance with one or more aspects of the present disclosure;

FIG. 15 is an illustrative user interface for receiving and processing tax data and alerting individuals of a needed correction and/or issue associated with the tax data in accordance with one or more aspects of the present disclosure;

FIG. 16 is an illustrative user interface for receiving and processing tax data and alerting individuals of a needed correction and/or issue associated with the tax data in accordance with one or more aspects of the present disclosure;

FIG. 17 is an illustrative user interface for receiving and processing tax data and alerting individuals of a needed correction and/or issue associated with the tax data in accordance with one or more aspects of the present disclosure;

FIG. 18 is an illustrative user interface for receiving and processing tax data and alerting individuals of a needed correction and/or issue associated with the tax data in accordance with one or more aspects of the present disclosure;

FIG. 19 is an illustrative user interface for receiving and processing tax data and alerting individuals of a needed correction and/or issue associated with the tax data in accordance with one or more aspects of the present disclosure;

FIG. 20 is an illustrative user interface for receiving and processing tax data and alerting individuals of a needed correction and/or issue associated with the tax data in accordance with one or more aspects of the present disclosure;

FIG. 21 is an illustrative user interface for receiving and processing tax data and alerting individuals of a needed correction and/or issue associated with the tax data in accordance with one or more aspects of the present disclosure;

FIG. 22 is an illustrative user interface for receiving and processing tax data and alerting individuals of a needed correction and/or issue associated with the tax data in accordance with one or more aspects of the present disclosure;

FIG. 23 is an illustrative user interface for receiving and processing tax data and alerting individuals of a needed correction and/or issue associated with the tax data in accordance with one or more aspects of the present disclosure;

FIG. 24 is an illustrative user interface for receiving and processing tax data and alerting individuals of a needed correction and/or issue associated with the tax data in accordance with one or more aspects of the present disclosure;

FIG. 25 is an illustrative user interface for receiving and processing tax data and alerting individuals of a needed correction and/or issue associated with the tax data in accordance with one or more aspects of the present disclosure; and

FIG. 26 is an illustrative user interface for receiving and processing tax data and alerting individuals of a needed correction and/or issue associated with the tax data in accordance with one or more aspects of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

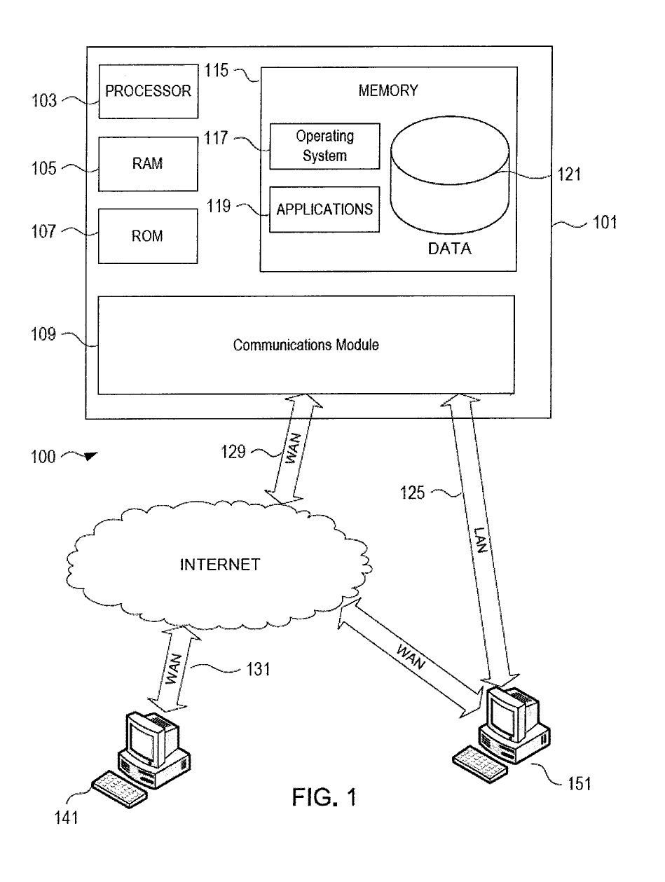

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

I/O 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of account information and account holder information for the entire business, allowing interoperability between different elements of the business residing at different physical locations.

The server 110 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the server 101 according to an illustrative embodiment of the disclosure may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

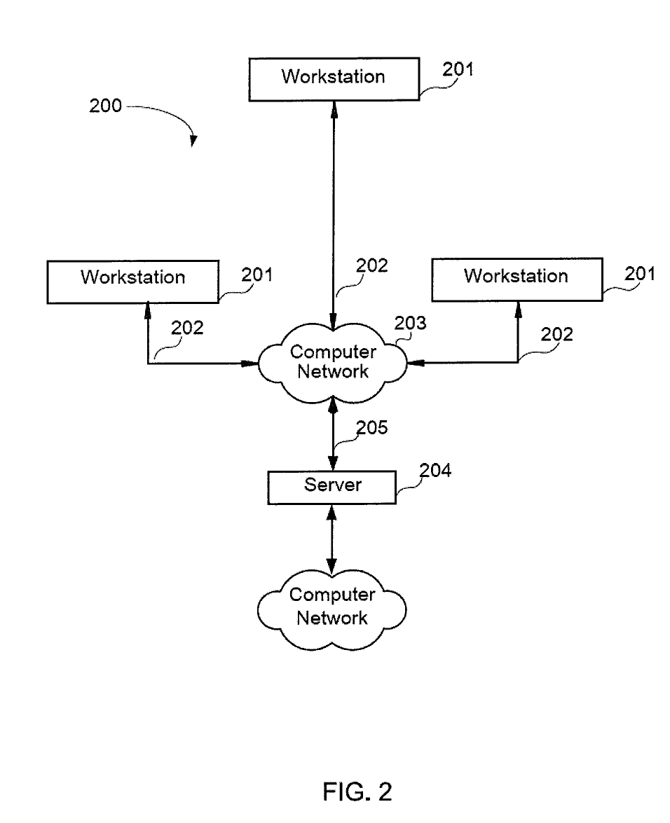

Referring to FIG. 2, an illustrative system 200 for implementing methods according to the present disclosure is shown. As illustrated, system 200 may include one or more workstations 201. Workstations 201 may be local or remote, and are connected by one or communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

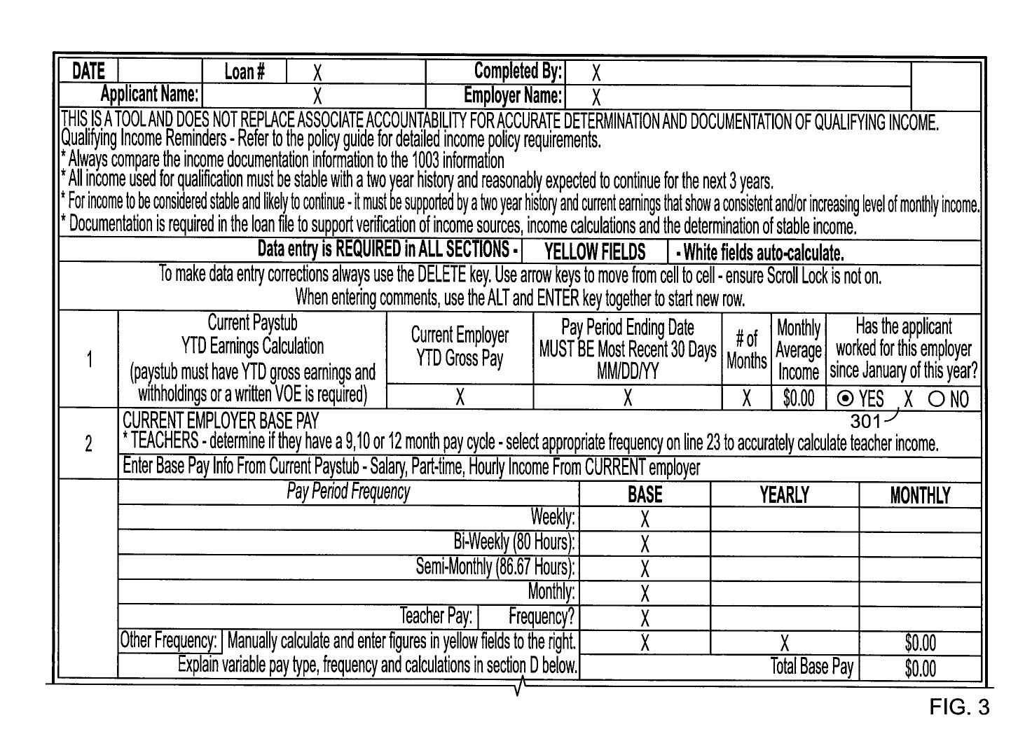

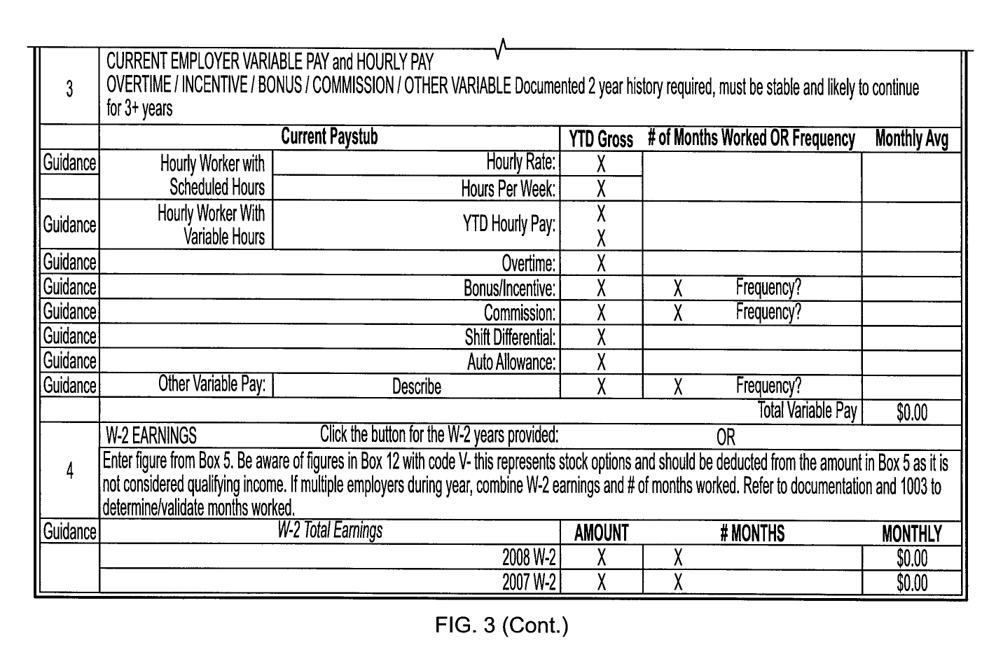

FIG. 3 is an illustrative user interface for receiving and processing loan data and alerting individuals of a needed correction and/or issue associated with the loan data in accordance with one or more aspects of the present disclosure. Loan policies and procedures of an entity must be maintained to ensure that when selling a loan to a different entity, the loan will be sold without issue. When you have different individuals analyzing loan data, the individuals will vary the end result determination of loan numbers based upon their individual experience levels, individual interpretation of policies, manual calculations, and review of loan related documentation. As such, a customer seeking a loan may be rejected from obtaining a loan by one reviewing employee in comparison to another that may find the income number for the customer to warrant a specific level of funding for a loan.

A consistent methodology to coordinate one or more policies and/or procedures of a loan entity is implemented in accordance with one or more aspects of the present disclosure. Aspects for the present disclosure describe a standardizing tool for qualifying income for wagering applicants/customer. A loan offering entity must review wage earning records of a customer seeking a loan to justify an amount of a loan to offer the customer. A standardized mechanism for evaluating customer income while alerting loan analyzing employees of the entity of red flags, e.g., issues or items needing review and/or correction, is described herein.

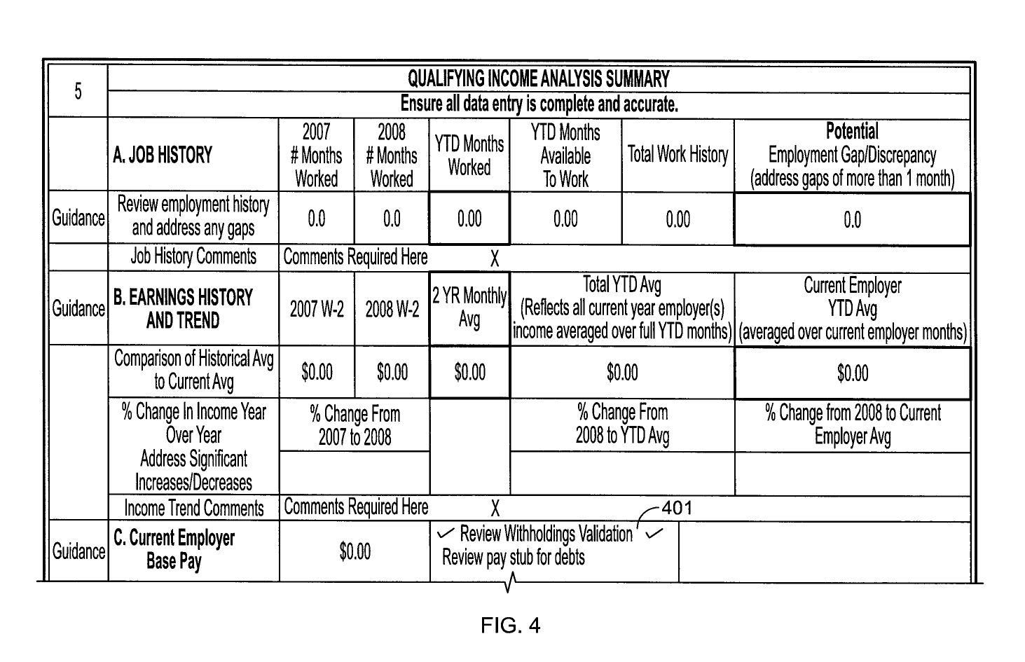

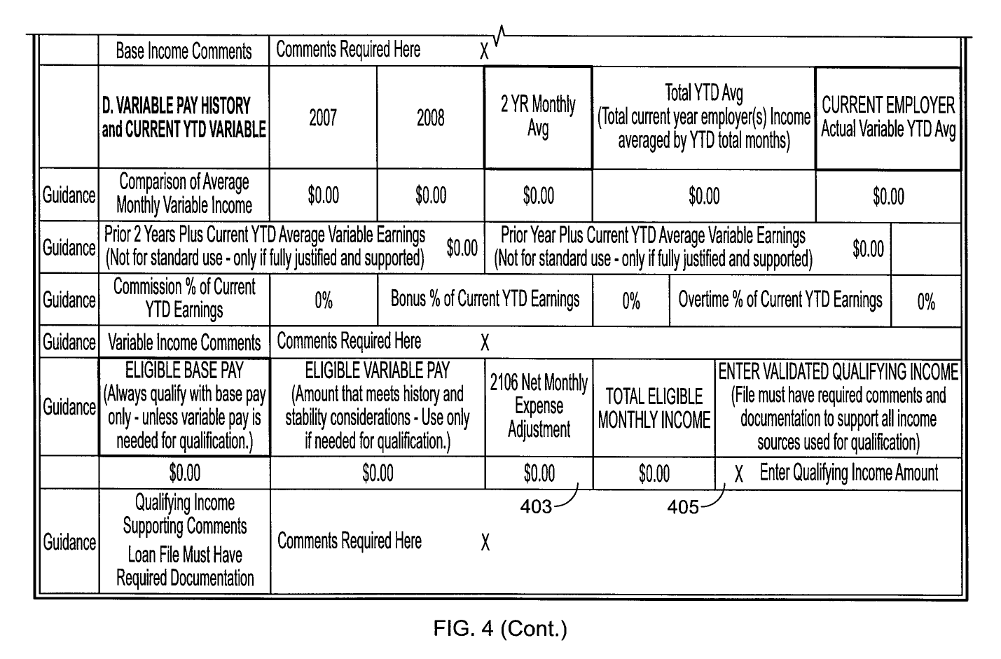

FIG. 3, in conjunction with FIG. 4, illustrates one or more user interfaces that an analyzing employee of the loan offering entity may utilize in entering wage earning data received from a customer desiring a loan and/or other locations, such as an external database, such as an Internal Revenue Service (IRS) database. Entry fields may be color coded, such as yellow, to indicate fields that may be populated by outside data, such as the data entered by the analyzing employee and/or data received from an external database. Entry fields that are automatically calculated by the system may be shown in another color or manner, such as white, to indicate that such fields are auto-populated upon entry of other data in the yellow fields. For ease of description, one or more of the fields herein may be auto-populate fields and/or auto-calculation fields. For the illustrative examples of user interface described herein for the various figures, fields with an “X” included are fields that may be auto-populated by data pulled form an external source and/or data directly entered by an analyzing employee.

Fields marked by “X” in FIG. 3 and in FIG. 4 may be entered by an analyzing employee of the loan offering entity as part of the process of evaluating the income of a customer seeking a loan. For ease of reference to the employee and/or some other individual reviewing the resulting loan documentation, sections of the data entries fields are broken down by respective categories. Examples include “Current Paystub YTD Earnings Calculation,” “Current Employer Base Pay,” “Current Employer Variable Pay and Hourly Pay,” “W-2 Earnings,” and a “Qualifying Income Analysis Summary.”

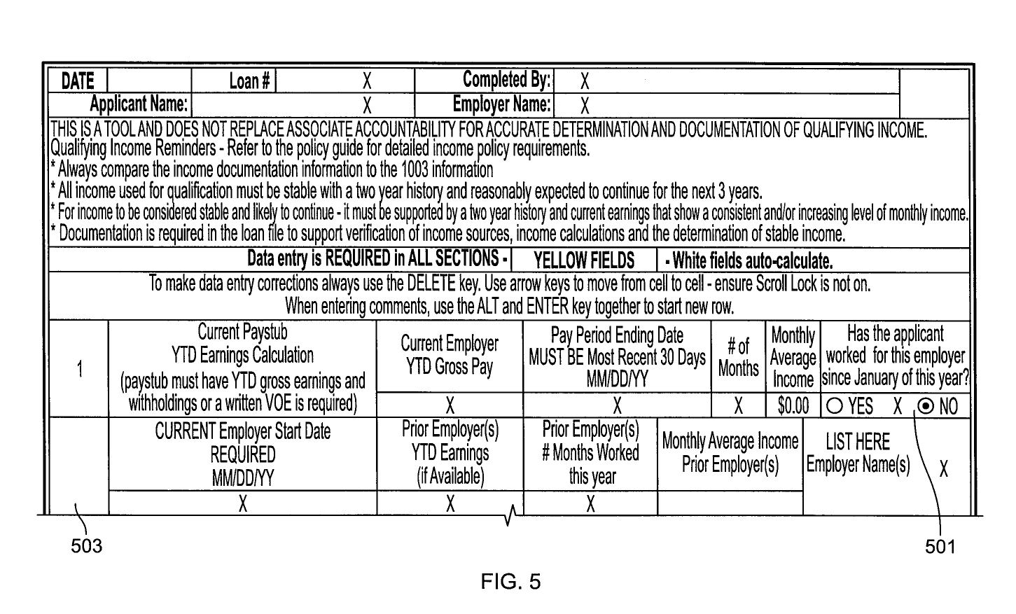

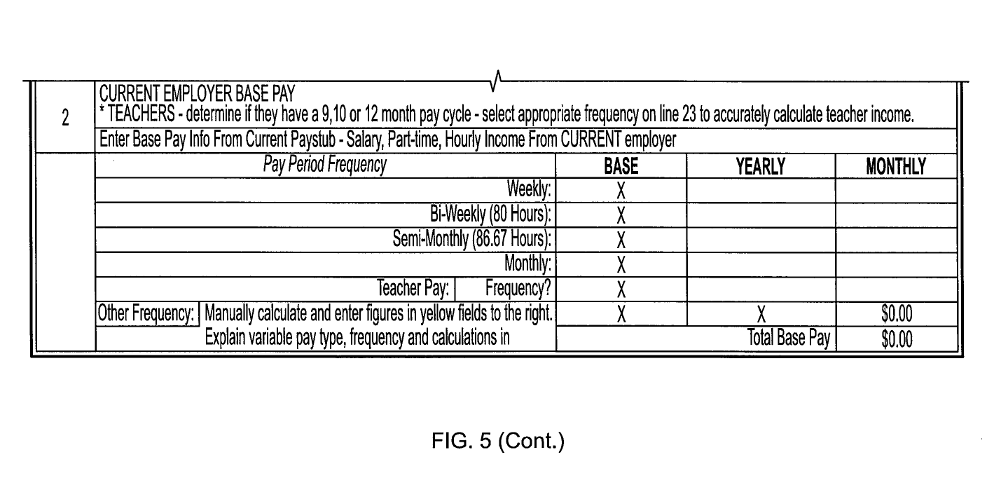

Looking at FIG. 3, for section 1, shown as “Current Paystub YTD Earnings,” data fields correlating to YTD gross pay, pay period ending date, and number of months work may be filled by an analyzing employee based upon documentation received from the customer desiring a loan. FIG. 3 illustrates a default example user interface and/or a user interface for when the documentation reflects that the applicant/customer has worked for the employer since January of this year, reference 301. FIG. 5 illustrates an example user interface to account for situations where the documentation reflects that the applicant/customer has not worked for the employer since January of this year, reference 501. In such an example, as shown in FIG. 5, a new row is automatically generated to account for entry of additional information regarding the former employer of the applicant/customer seeking the loan. Additional information thus may be required for the system to properly produce a resulting loan file for the customer. Such additional information may be entered by the analyzing employee and/or auto-populated based upon other documentation received from the applicant/customer.

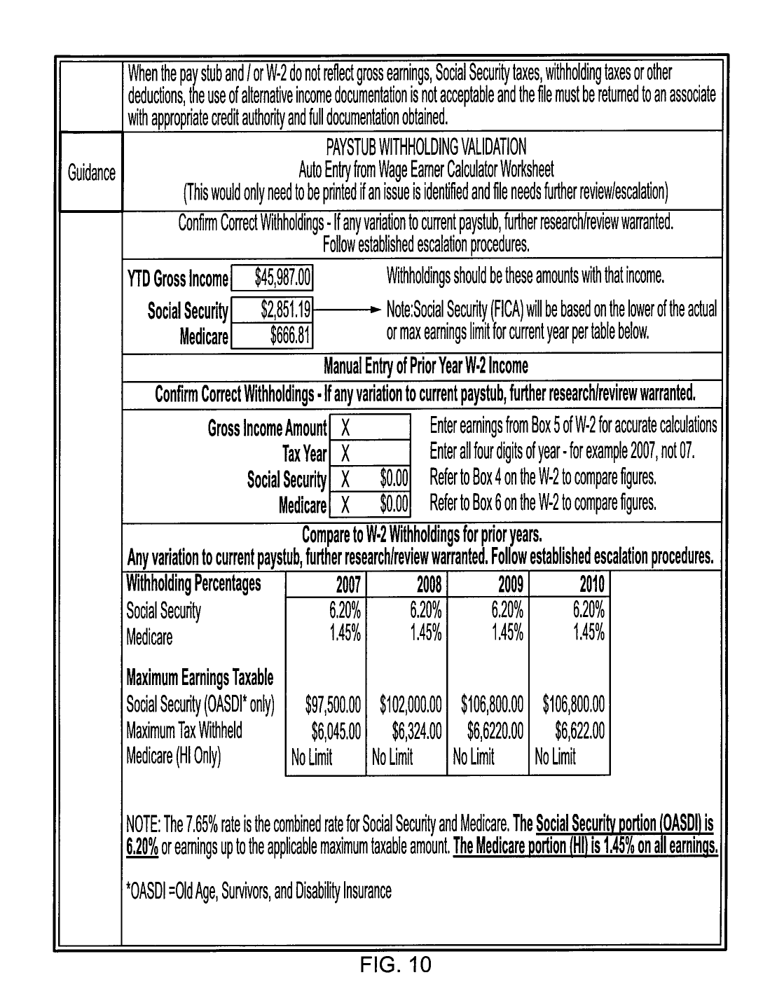

Having entered information with respect tot section 1, “Current Paystub YTD Earnings Calculation,” a confirmation of the data may be initiated by the system to evaluate the potential for fraud. There are typically three reasons why the withholding validation figures may vary on a paystub or W-2: 1) inaccurate accounting/calculations by employer of the loan desiring customer, 2) the loan desiring customer is a government employee who is exempt from certain deductions, or 3) this is potentially fraudulent documentation. FIG. 10 is an illustrative user interface for receiving and processing withholdings data and alerting individuals of a needed correction and/or issue associated with the withholdings data in accordance with one or more aspects of the present disclosure. FIG. 10 is an illustrative user interface to ensure review of withholdings documentation by an analyzing employee of the loan offering entity.

The user interface of FIG. 10 is a paystub withholding validation tool that automatically populates year to date gross earnings. The user interface calculates standard Social Security and other federal mandated deductions, such as Medicare to display to the analyzing employee what the deductions should be based upon the year to date gross income number. The analyzing employee then fills in the remainder of the form of FIG. 10, by utilizing the W-2 form produced by the loan desiring customer. As such, if the loan desiring customer is attempting to perform a fraud with a fake W-2 form of inconsistent numbers, the analyzing employee can confirm that the calculated numbers that were auto-populated from the data entered in FIG. 3 and FIG. 4 are correct against the calculated entries directly taken from the W-2 form an entered in FIG. 10.

Upon finding one or more inconsistent numbers, the system may be configured to prevent the analyzing employee from completing the loan review process until the difference is resolved and/or may include a red flag to alert another individual of the issue. Such a determination as to whether to include a red flag to alert the employee may be based upon a threshold difference or just any difference at all. As such, the system allows an analyzing employee to correct a minor typographical error as well in case the employee merely inadvertently typed a decimal point in the wrong place when entering a number.

Still further one or more fields in FIG. 10 for confirmation of the W-2 earnings may be auto-populated by obtaining records associated with the loan desiring customer directly from an external source, such as from Internal Revenue Service (IRS) records. As such, an employee need not even have to enter the numbers in the system thus removing the potential for an incorrect entry by the employee. Confirming the records provided in W-2 forms and other documentation received from a loan desiring customer directly against accessible IRS records ensures even greater confidence in minimizing both fraud and data entry errors in a loan processing process.

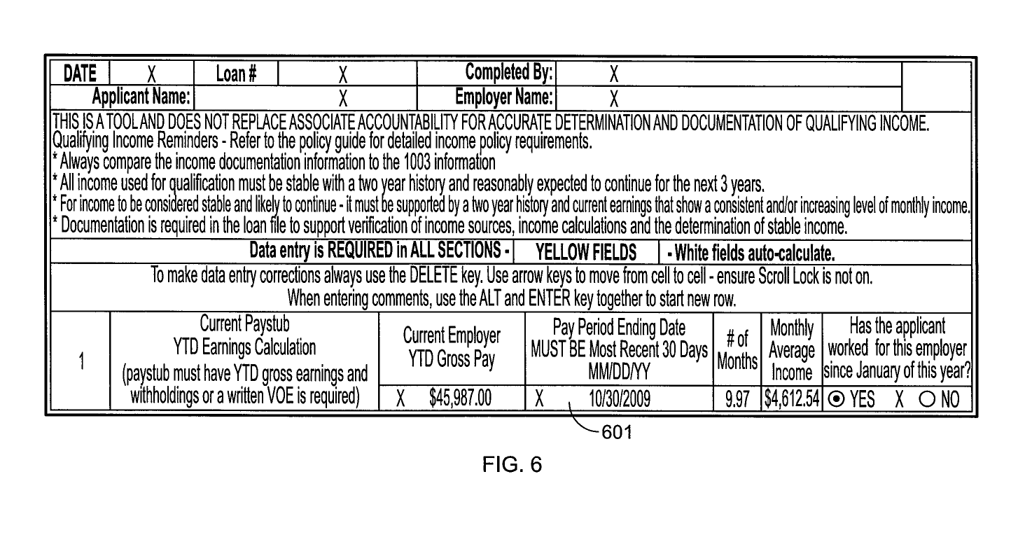

FIG. 6 is a portion of the illustrative user interface of FIG. 3 for receiving and processing loan data and alerting individuals of a needed correction and/or issue associated with the loan data in a different state in accordance with one or more aspects of the present disclosure. FIG. 6 illustrates an example of where data has been entered with respect to section 1, “Current Paystub YTD Earnings Calculation.” Having entered a YTD gross pay of $45,987.00, the analyzing employee may look to the paystub provided by the applicant/customer to see the pay period ending date on the paystub. In this example the paystub ending date entry 601 is Oct. 30, 2009. To minimize the potential for fraud and/or inaccurate calculations for loan processing, mechanisms may be in place to ensure that paystubs within a determined time frame are utilized.

For example, a policy may be in place that only paystubs within the last 30 days may be utilized for calculation purposes. Such a policy helps to ensure that older inaccurate data is not being utilized for the loan processing documentation. In the case of a paystub being use with a date of more than 30 days prior to the current date of entry by the analyzing employee, data entry field 601 may alert the analyzing employee, such as turning red in color, to the fact that a policy is not being met by entry of this data. Such a policy may be very important to the loan offering entity. In such a case, the system may prevent further data entry until the correction is made, require the analyzing employee to make documented evidence of the reason for continuing the processing, and/or may alert another individual of the failure of the policy being met, such as a reviewing loan officer of the loan offering employee.

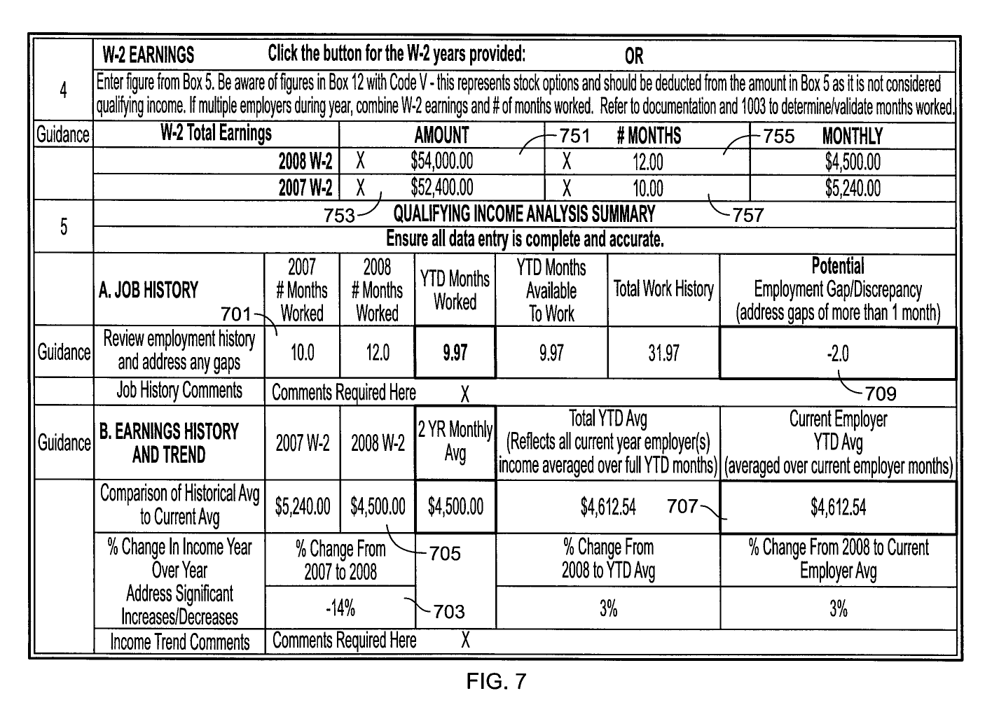

FIG. 7 is a portion of the illustrative user interface of FIG. 3 and FIG. 4 for receiving and processing loan data and alerting individuals of a needed correction and/or issue associated with the loan data in a different state in accordance with one or more aspects of the present disclosure. FIG. 7 illustrates an example of an alert being provided to an analyzing employee of the entity while determining an income number for a loan desiring customer. Visuals signals may be shown in red to alert the analyzing employee of the issue needing review and/or correction. As shown, based upon entry of data in data fields 751, 753, 755, and/or 757, other fields may be calculated and filled in. As shown, because data field 757 is shown as entering 10 months and not 12 months of employment in the 2007 W-2 form of the applicant/customer, data fields 701, 703, 705, 707, and 709 alert the analyzing employee of the issue. Such an alert may be a change of color of the text in the data field and/or the box of the data field, and/or some other form of an alert, such as audio, audio and visual, and or any of a number of other alert mechanisms. With the alerts in place, the system may be configured to prevent further processing of the loan file of the applicant until the issue is corrected, justified, and/or handled in some other manner.

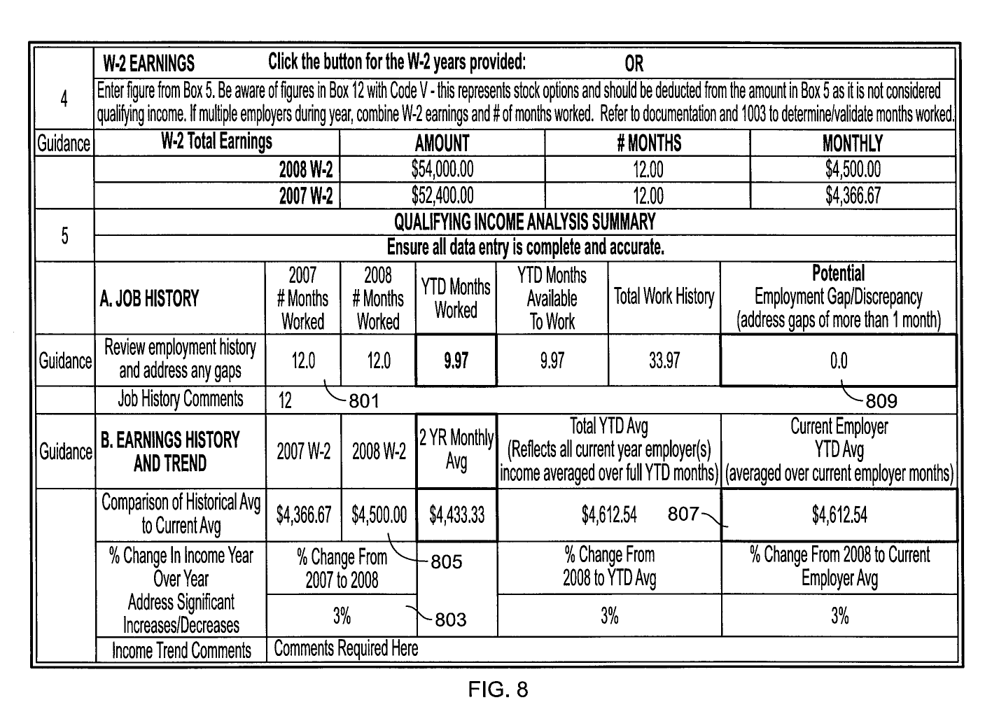

FIG. 8 is the illustrative user interface of FIG. 7 for receiving and processing loan data and alerting individuals of a needed correction and/or issue associated with the loan data in a corrected state in accordance with one or more aspects of the present disclosure. In the example of FIG. 8, the entry of 10 months in data field 757 may have simply been a clerical error entry on the part of the analyzing employee in entering data. Since the employee was alerted to the issue immediately, the problem could be corrected, as shown in FIG. 8 in data fields 801, 803, 805, 807, and 809 without the alert/red flag in place any longer. The processing of the loan file then may continue with accurate data in place.

Such a system of alerting the employee assists the employee in fraud detection. The system may be configured to confirm that all individual earnings of a paystub and base pay of an applicant/customer seeking a loan match to year to date average earnings of the applicant/customer. When fraudulent documentation is produced by the applicant/customer, there can be a failure in manual review to check all numbers and calculations done manually to ensure a figure has not been altered as in a fraud scenario.

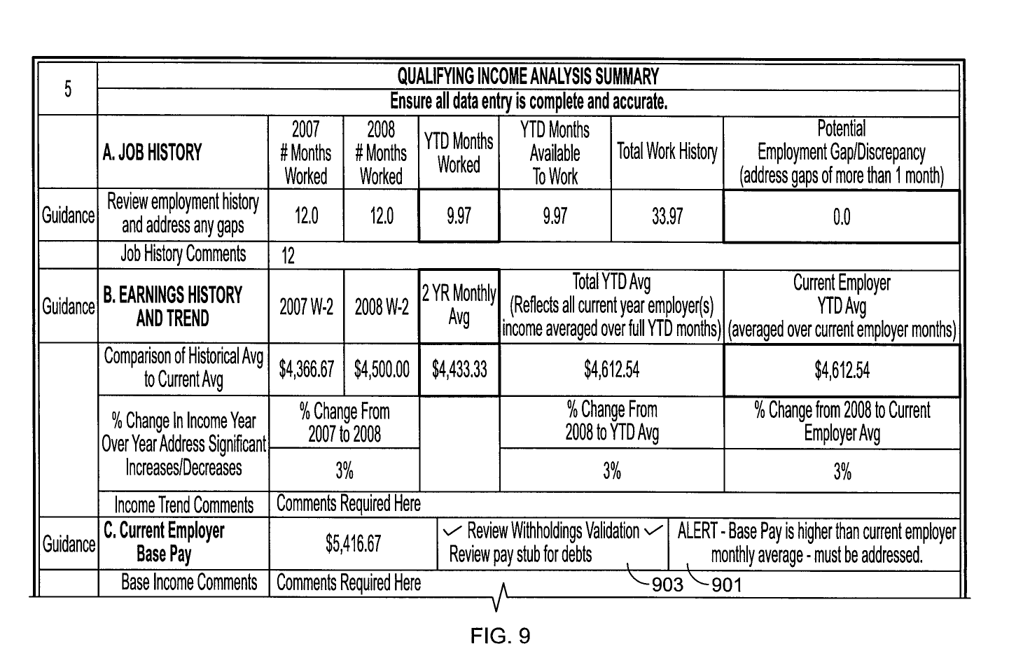

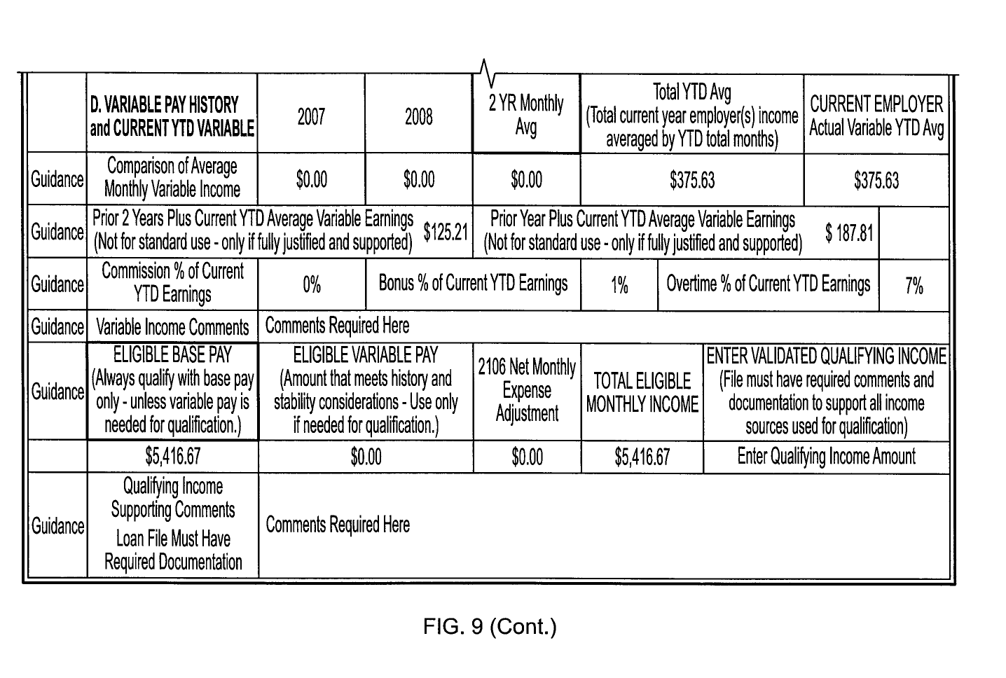

FIG. 9 is a portion of the illustrative user interface of FIG. 4 for receiving and processing loan data and alerting individuals of a needed correction and/or issue associated with the loan data in a different state in accordance with one or more aspects of the present disclosure. FIG. 9 illustrates a unique scenario of the summary portion of the user interface of FIG. 4 where an alert is being brought to the attention of the analyzing employee of the loan offering entity. In this example, as shown by reference 901, an alert may be signaled that the base pay entry is higher than the current employer monthly average and that this alert must be addressed by the analyzing employee. Any of a number of reasons may account for this discrepancy that is not fraudulent in nature, including a recent customer promotion with a significant increase in salary, an inaccurate entry by the analyzing employee when entering data earlier in the process, and other reasons. However, such an alert does help in accounting for the potential for fraud by the applicant/customer. As such, the system may be configured to prevent further processing of the loan file until the alert is addressed by way of justification for the discrepancy, correction of the discrepancy, and/or some other action by the analyzing employee.

Still further, FIG. 9 illustrates an example where an analyzing employee may be prompted to take some other action, such as by prompting data field 903. Such a field may require a confirmation by the analyzing employee that the other actions where completed. In this case, the analyzing employee is asked to “Review Withholdings Validation,” addressed for example in FIG. 10, and “Review pay stub debts.” Once completed by the analyzing employee, the analyzing employee may check the box to identify to the system the completion of the action and the acknowledgement of the completion by the analyzing employee. Such an action item check-list confirmation may be utilized by an entity to ensure compliance of the analyzing employee to standardized policies and/or procedures of the entity in processing loan files. In still other examples, data field 903 simply may be a prompt to the analyzing employee without an explicit requirement for confirmation of completing the actions.

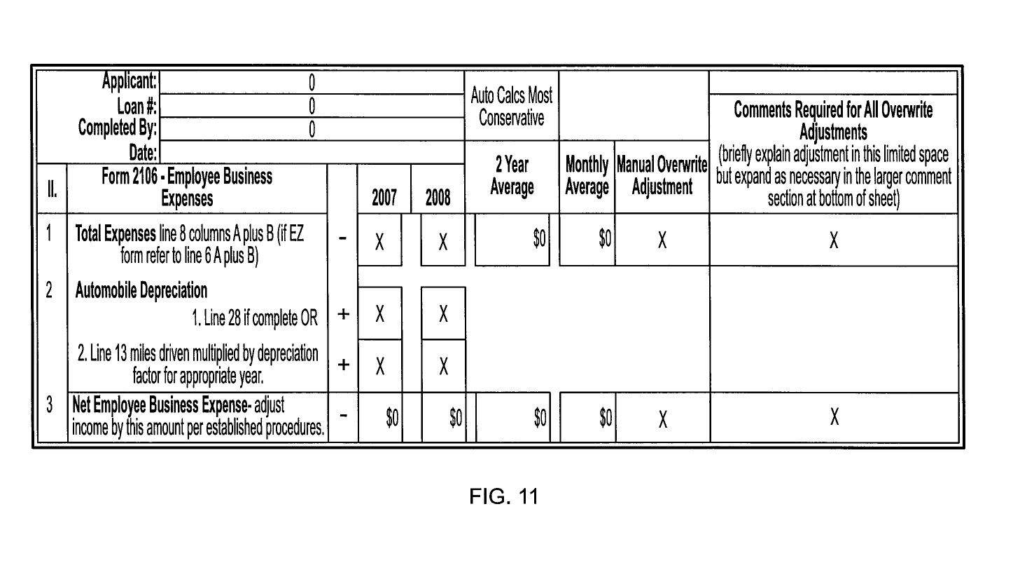

FIG. 11 is an illustrative user interface for receiving and processing business expense data associated with FIG. 4 and alerting individuals of a needed correction and/or issue associated with the data in accordance with one or more aspects of the present disclosure. Under certain circumstances, applicant/customer business expenses may be accounted for in evaluating a loan for the applicant/customer. FIG. 11 allows for entry of such business expenses. Having entered the data in FIG. 11, the system may perform the necessary calculations to account for such in data field 403 of FIG. 4 for the loan processing. As such, this additional information may directly and clearly be taken into account for justification for the end result income number of the applicant/customer. With all of the data entered with respect to the qualifying income of the customer, the analyzing employee can easily find all calculations for all possible earnings determinations of the customer in order to enter a qualifying income amount for the individual that is used to justify the amount of a loan that the customer may be eligible for.

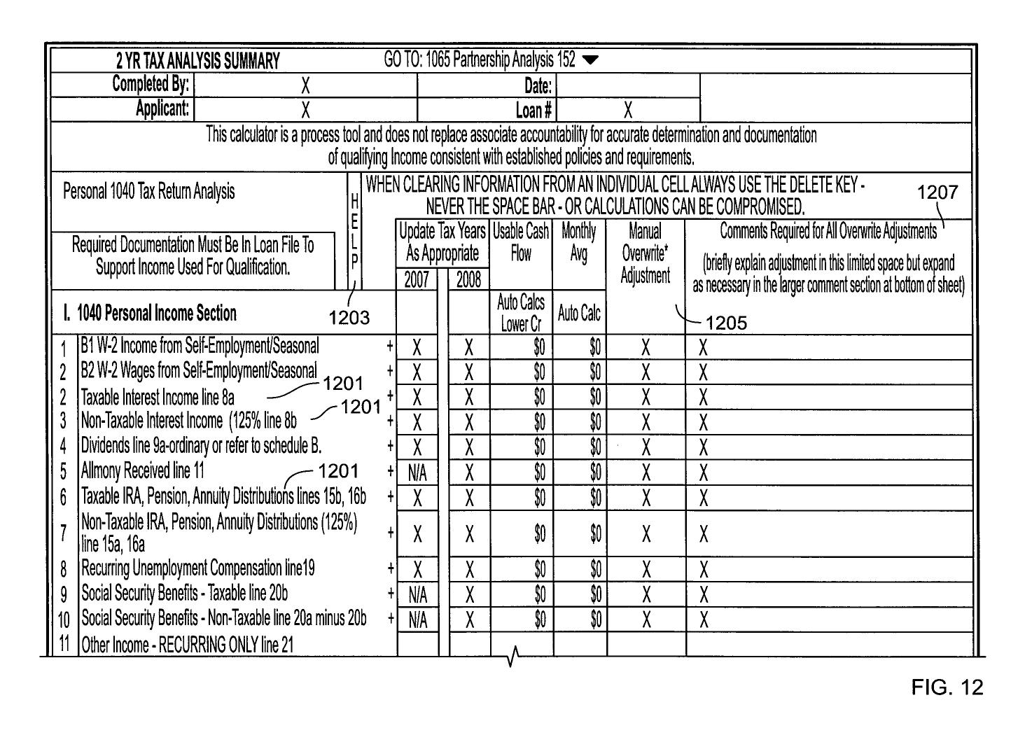

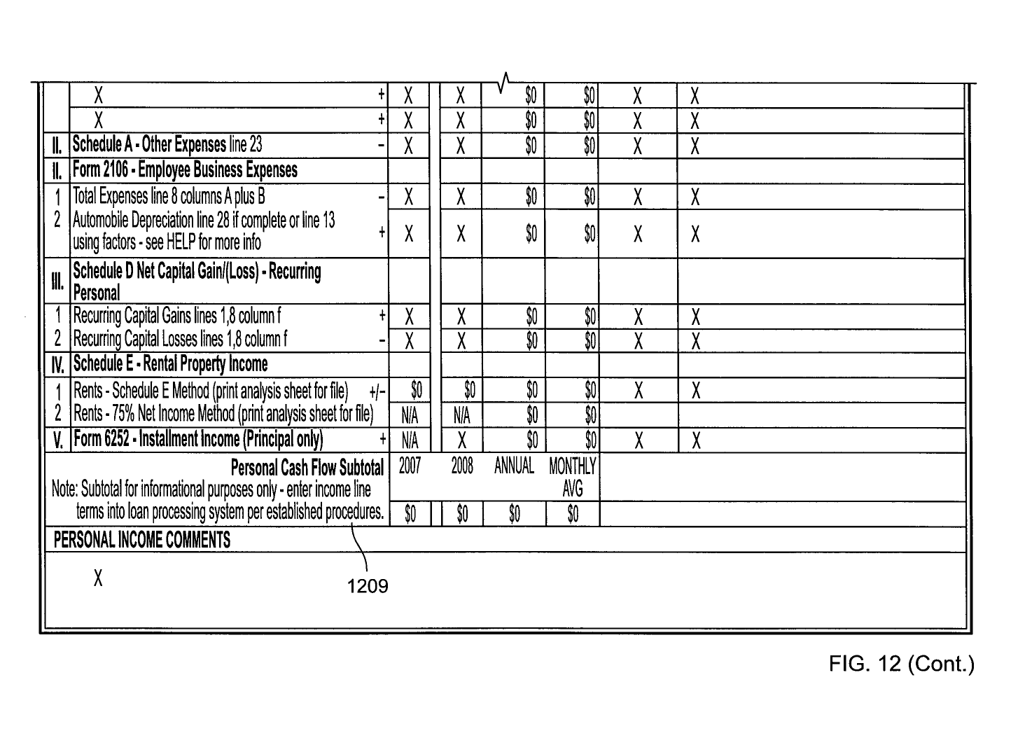

The illustrative user interfaces shown in FIGS. 3-11 may be utilized with respect to earnings of a customer that works for a company. Similarly, as illustrated below with respect to FIGS. 12-26, the user interfaces therein may be utilized with respect to earnings of a customer for earnings through other means, such as rental earnings, royalty earnings, and self-employment. As such, for example, in the situation of an applicant that works during the day for a company and then has a self-employment business on weekends, earnings of the applicant/customer from the company employment may be calculated based on the user interfaces of FIGS. 3-11 and the earnings of the self-employment may be calculated based on the user interfaces of FIGS. 12-26.

There may be a variation between entity employees in how to perform tax analysis. Aspects of the present disclosure bring a consistent structure and approach by taking the conventional paper-based analysis worksheets and turning them into online forms that automatically calculate and immediately provide alerts and/or notifications to an analyzing employee.

Aspects of the present disclosure provide direction to analyzing employees on where to obtain figures from the tax returns to ensure accuracy and consistency. Information may be consolidated on a main worksheet and over-write adjustments may be allowed. Calculations may be configured to perform the most conservative calculations but the ability to manually override a different amount if supported by policy and documentation may be included. Clean, clear documentation that shows how income was calculated may be produced and supporting comments may be displayed.

FIGS. 12-26 illustrate user interfaces that may be utilized with respect to earnings of a customer for earnings through other means, such as rental earnings, royalty earnings, and self-employment. FIG. 12 is an illustrative user interface for receiving and processing tax data and alerting individuals of a needed correction and/or issue associated with the tax data in accordance with one or more aspects of the present disclosure. As shown, FIG. 12 illustrates a 2 year tax analysis summary of the customer/applicant.

Upon entry of data into the various data fields, a personal cash flow subtotal for the applicant/customer can be generated as referenced by 1209. For assisting an analyzing employee as to the source of data for inclusion in the various data fields, one or more resource guidelines may be provided to the analyzing employee. For example, resource guidelines 1201 are shown. Resource guidelines 1201 identify the documentation source for gathering the needed data for processing by the system. For example, particular line numbers correlated against a standard government issued form may be utilized as the resource guideline for identifying where on the government issued form that was included in the applicant's/customer's documentation to find the needed data.

In addition, other forms of assistance may be provided to the analyzing employee for entering respective data fields. One or more help prompters 1203 may be accessed by the analyzing employee. For any particular row of the user interface, a help prompter may be accessed. The help prompter 1203 may provide additional information on the particular data to be entered. Such additional information may include noted fraudulent indicators, expected ranges for an amount, secondary sources/documentation to confirm entries, and/or other information.

As shown in FIG. 12, column 1205 allows for an analyzing employee to enter an adjustment that manually overrides the data used for calculation purposes that was entered for a particular row. Any of a number of reasons may exist for the allowance of an adjustment to the data. In each case, the system may be configured to require the entry of a comment, such as the justification for the adjustment, in a corresponding data field in column 1207. The system may not allow for the override without the inclusion of a justifiable entry in 1207. Having entered all of the needed data entries in the user interface, a resulting personal cash flow subtotal 1209 may be generated. This resulting number may be the result of calculations taking into account the one or more adjustments entered in column 1205.

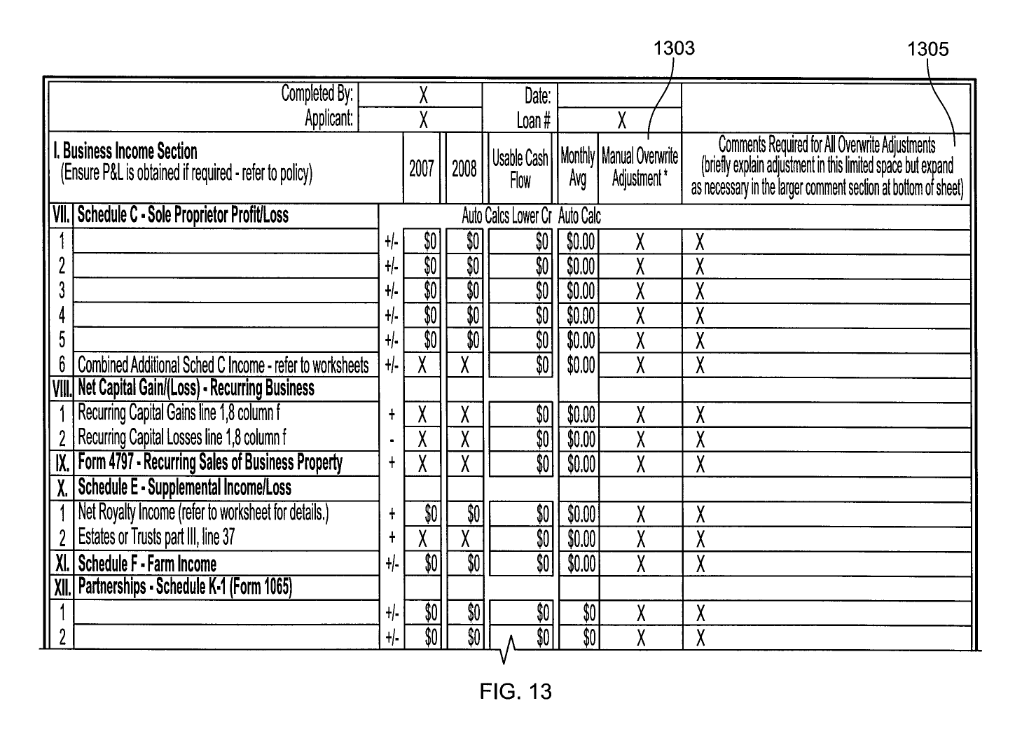

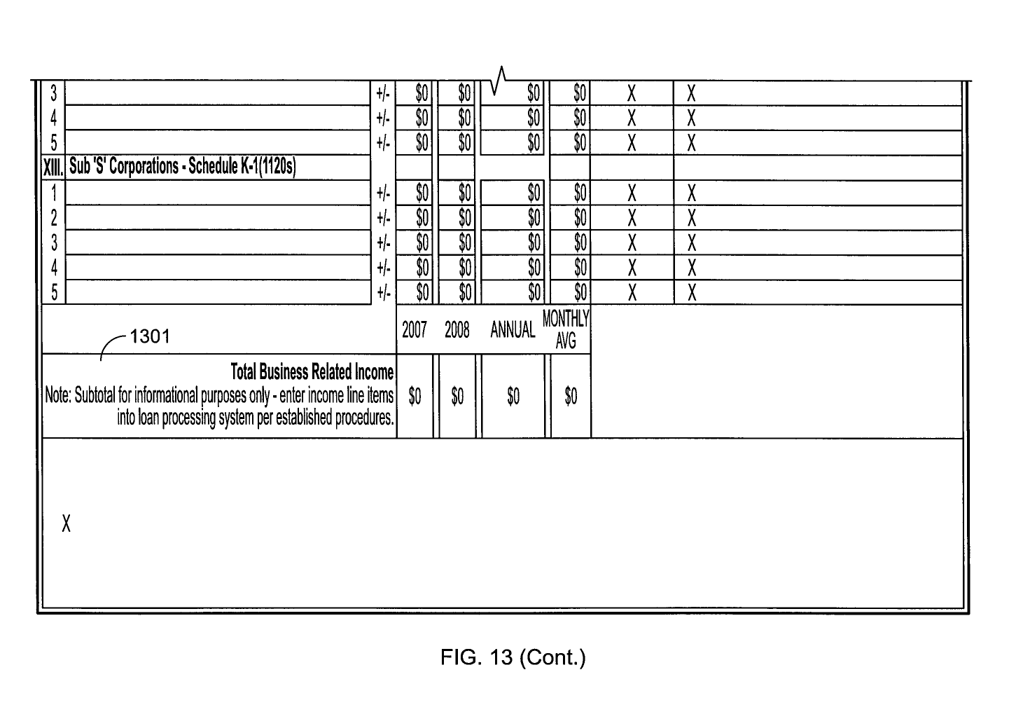

FIG. 13 is an illustrative user interface for receiving and processing tax data and alerting individuals of a needed correction and/or issue associated with the tax data in accordance with one or more aspects of the present disclosure. Upon entry of data into the various data fields, a total business related income for the applicant/customer can be generated as referenced by 1303. For assisting an analyzing employee as to the source of data for inclusion in the various data fields, one or more resource guidelines may be provided to the analyzing employee as similarly described above with respect to FIG. 12. In addition, other forms of assistance may be provided to the analyzing employee for entering respective data fields, such as one or more help prompters as similarly described above with respect to FIG. 12.

Column 1303 allows for an analyzing employee to enter an adjustment that manually overrides the data used for calculation purposes that was entered for a particular row. Any of a number of reasons may exist for the allowance of an adjustment to the data. In each case, the system may be configured to require the entry of a comment, such as the justification for the adjustment, in a corresponding data field in column 1305. The system may not allow for the override without the inclusion of a justifiable entry in 1205. Having entered all of the needed data entries in the user interface, a resulting total business related income 1301 may be generated. This resulting number may be the result of calculations taking into account the one or more adjustments entered in column 1303.

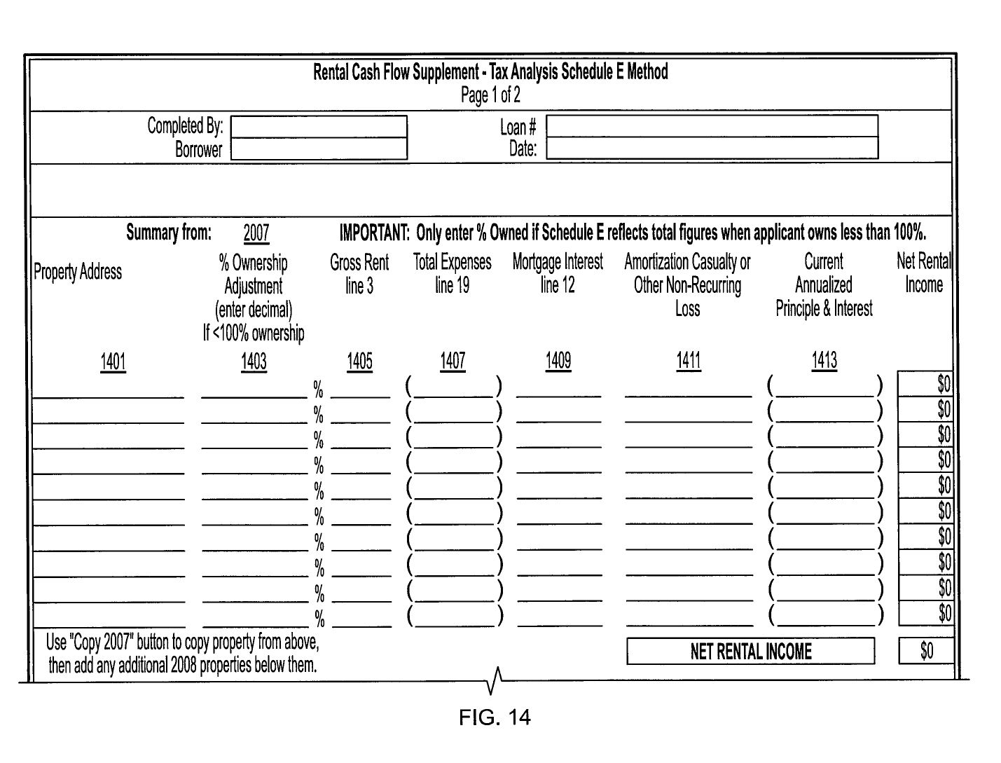

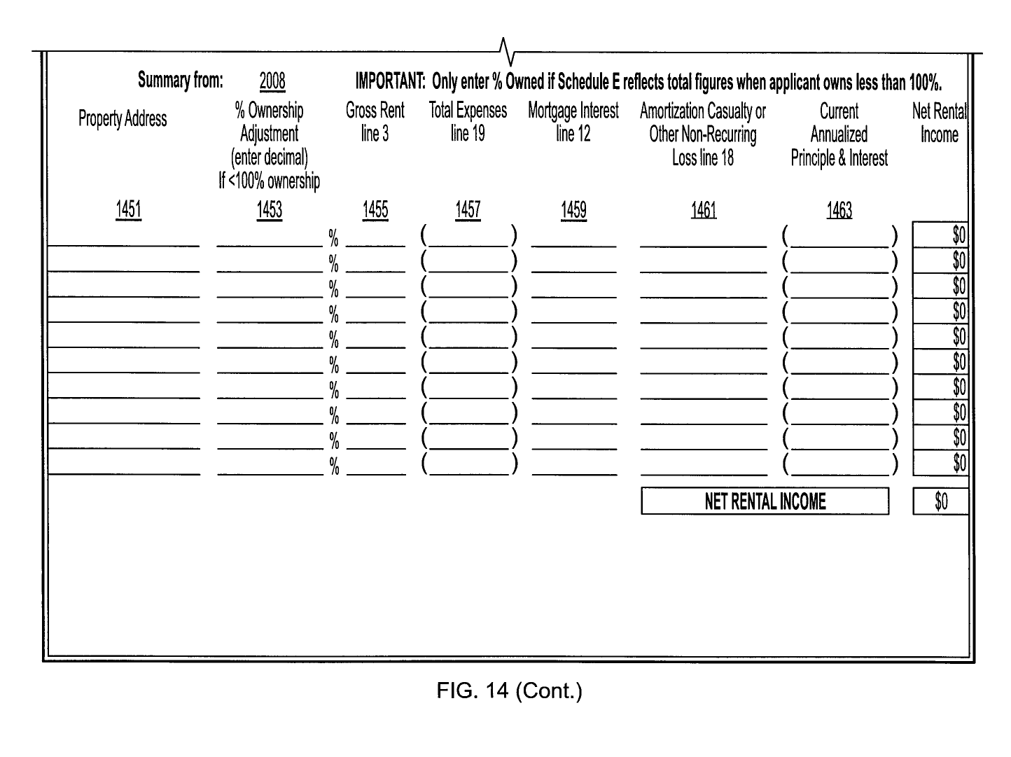

FIG. 14 is an illustrative user interface for receiving and processing tax data and alerting individuals of a needed correction and/or issue associated with the tax data in accordance with one or more aspects of the present disclosure. FIG. 14 illustrates an example schedule E form correlating to rental property income that an applicant/customer may have in the documentation she provided for receiving a loan. One or more data fields in columns 1401-1413 and 1451-1463 may be filled by an analyzing employee based upon documentation received from the applicant/customer and/or some other source. Data fields 1401-1413 correlate to data with respect to the year 2007 and data fields 1451-1463 correlate to data with respect to the year 2008. Net rental incomes for the respective years may be calculated and displayed to the analyzing employee.

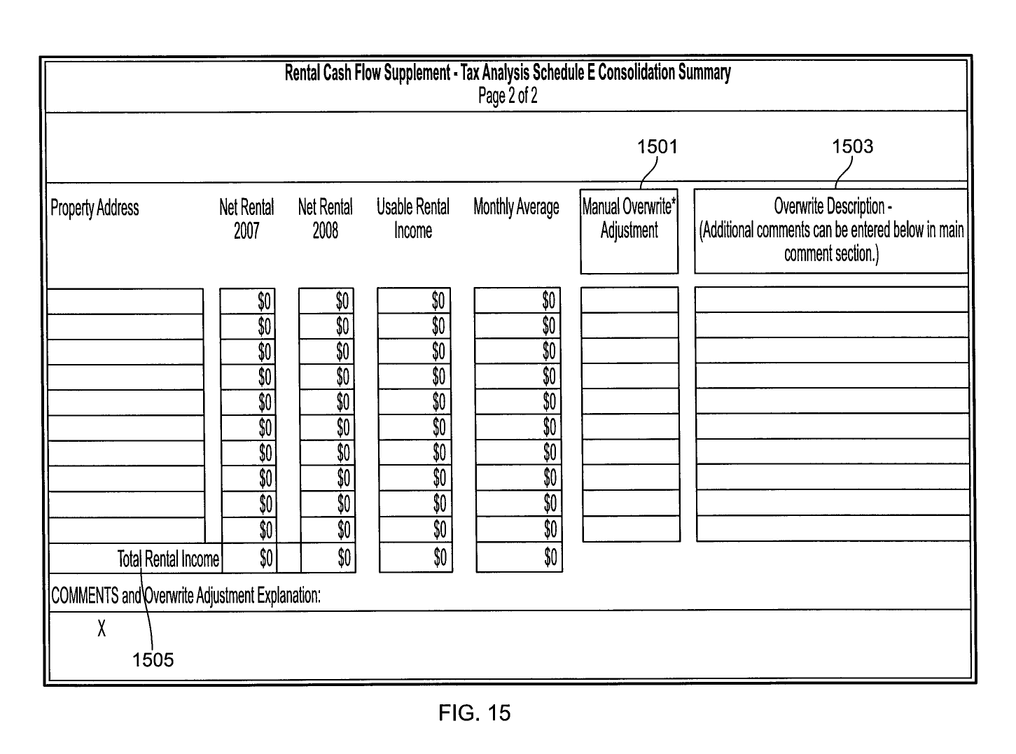

Proceeding to FIG. 15, one or more of the fields may be auto-populated by data entered in one or more of data fields 1401-1413 and 1451-1463. Column 1401 allows for an analyzing employee to enter an adjustment that manually overrides the data used for calculation purposes that was populated for a particular row from data entered in FIG. 14. Any of a number of reasons may exist for the allowance of an adjustment to the data by the analyzing employee based upon one or more policies and/or procedures of the loan offering entity. In each case, the system may be configured to require the entry of a comment, such as the justification for the adjustment, in a corresponding data field in column 1503. The system may not allow for the override without the inclusion of a justifiable entry in 1503. Having entered all of the needed data entries in the user interface, a resulting total rental income 1505 may be generated. This resulting number may be the result of calculations taking into account the one or more adjustments entered in column 1501.

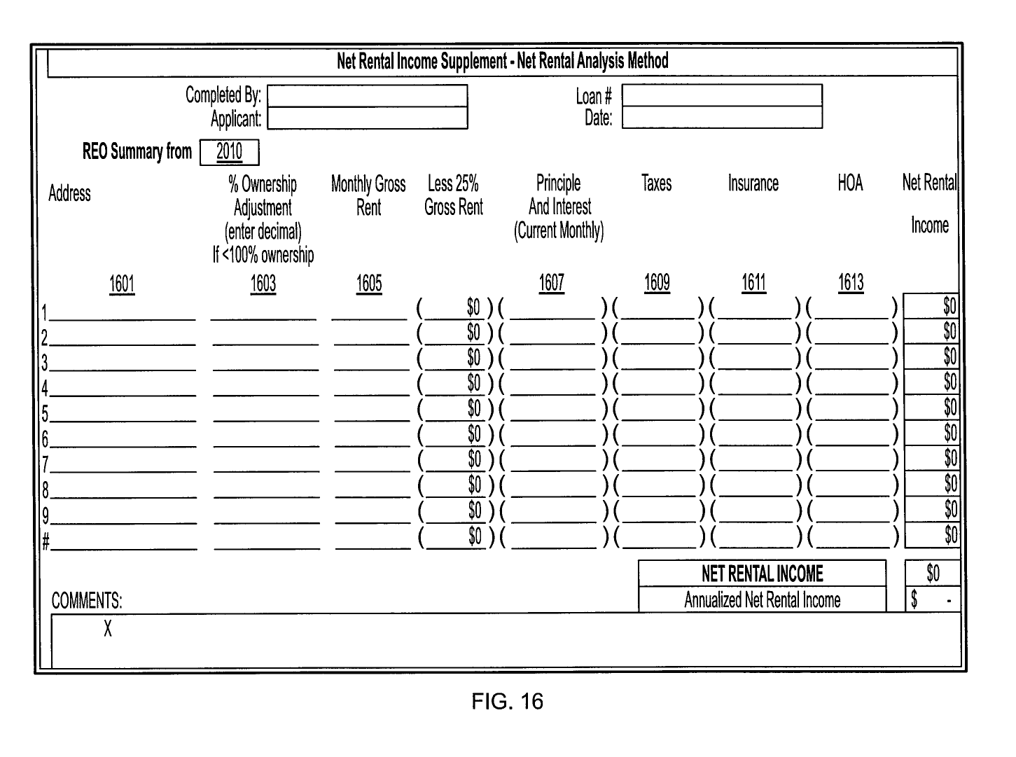

FIG. 16 is an illustrative user interface for receiving and processing tax data and alerting individuals of a needed correction and/or issue associated with the tax data in accordance with one or more aspects of the present disclosure. FIG. 16 illustrates an example net rental form correlating to rental property income that an applicant/customer may have in the documentation she provided for receiving a loan. One or more data fields in columns 1601-1613 may be filled by an analyzing employee based upon documentation received from the applicant/customer and/or some other source. Net rental income may be calculated and displayed to the analyzing employee.

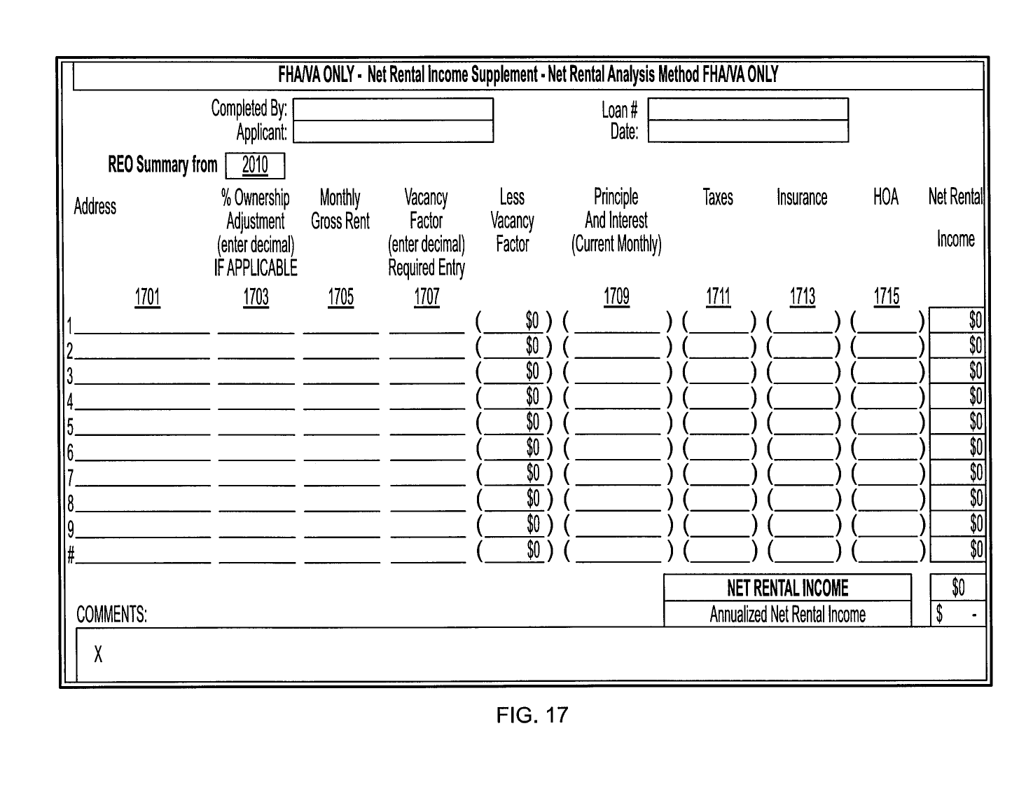

FIG. 17 illustrates an example net rental form correlating to rental property income that an applicant/customer may have in the documentation she provided for receiving a loan. Due to calculation difference that may be warranted between a standard rental property and a rental property in accordance with the Federal Housing Authority or the Veteran's Administration (FHA/VA) one or more data fields in columns 1701-1715 may be filled by an analyzing employee based upon documentation received from the applicant/customer and/or some other source. Net rental income may be calculated and displayed to the analyzing employee.

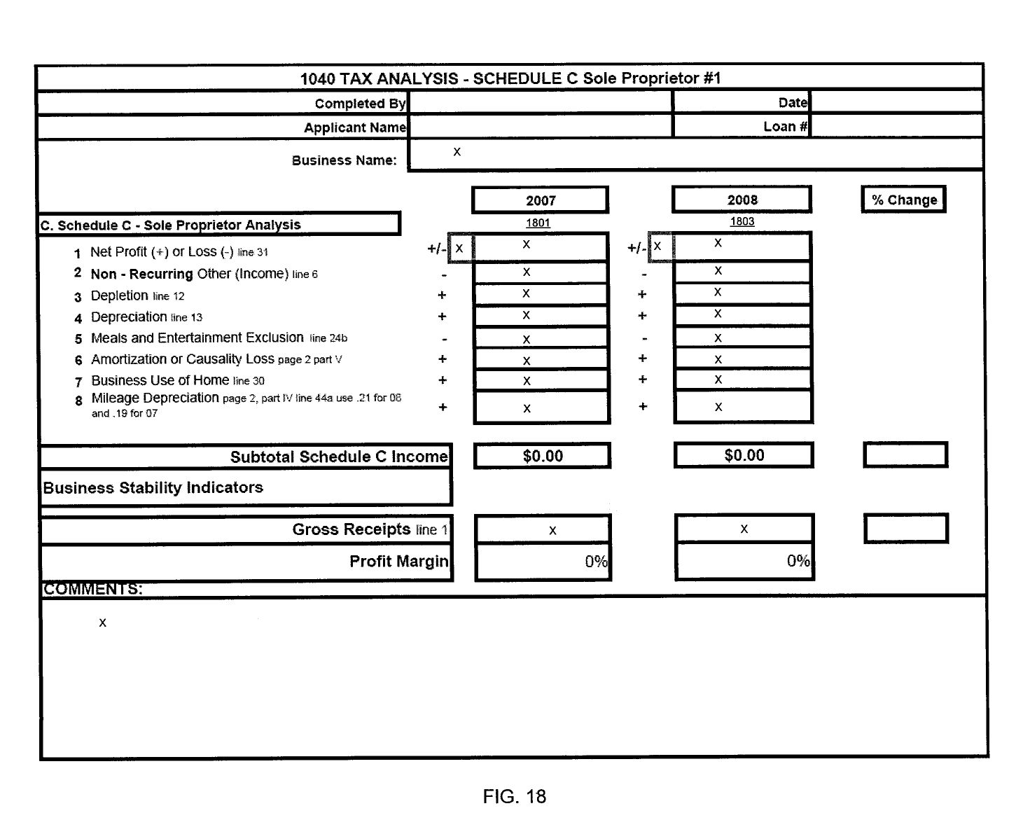

FIG. 18 is an illustrative user interface for receiving and processing tax data and alerting individuals of a needed correction and/or issue associated with the tax data in accordance with one or more aspects of the present disclosure. FIG. 18 illustrates an example schedule C form correlating to active businesses that an applicant/customer may have in the documentation she provided for receiving a loan. One or more data fields in columns 1801 and 1803 may be filled by an analyzing employee based upon documentation received from the applicant/customer and/or some other source. Data fields in column 1801 correlate to data with respect to the year 2007 and data fields in column in 1803 correlate to data with respect to the year 2008. A subtotal schedule C income for the respective years may be calculated and displayed to the analyzing employee. One or more schedule C forms may be provided as necessary to account for the different businesses that the applicant/customer owns.

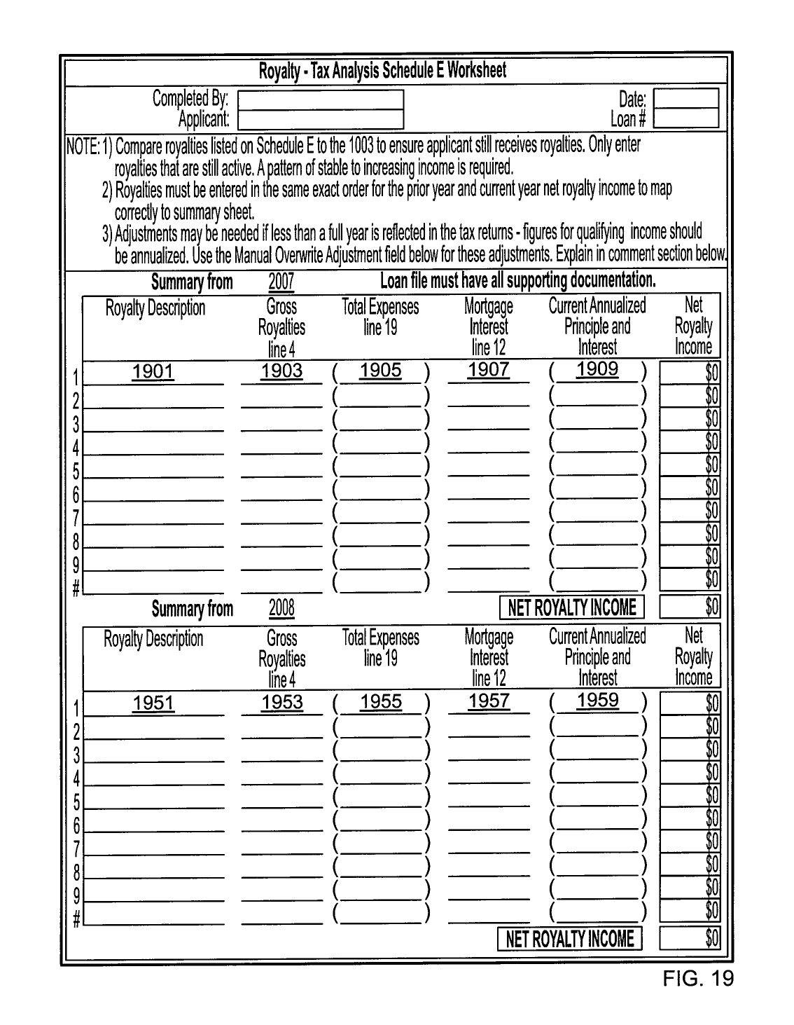

FIG. 19 is an illustrative user interface for receiving and processing tax data and alerting individuals of a needed correction and/or issue associated with the tax data in accordance with one or more aspects of the present disclosure. FIG. 19 illustrates an example schedule E royalty income form correlating to royalty income that an applicant/customer may have in the documentation she provided for receiving a loan. One or more data fields in columns 1901-1909 and 1951-1959 may be filled by an analyzing employee based upon documentation received from the applicant/customer and/or some other source. Data fields 1901-1909 correlate to data with respect to the year 2007 and data fields 1951-1959 correlate to data with respect to the year 2008. Net royalty incomes for the respective years may be calculated and displayed to the analyzing employee.

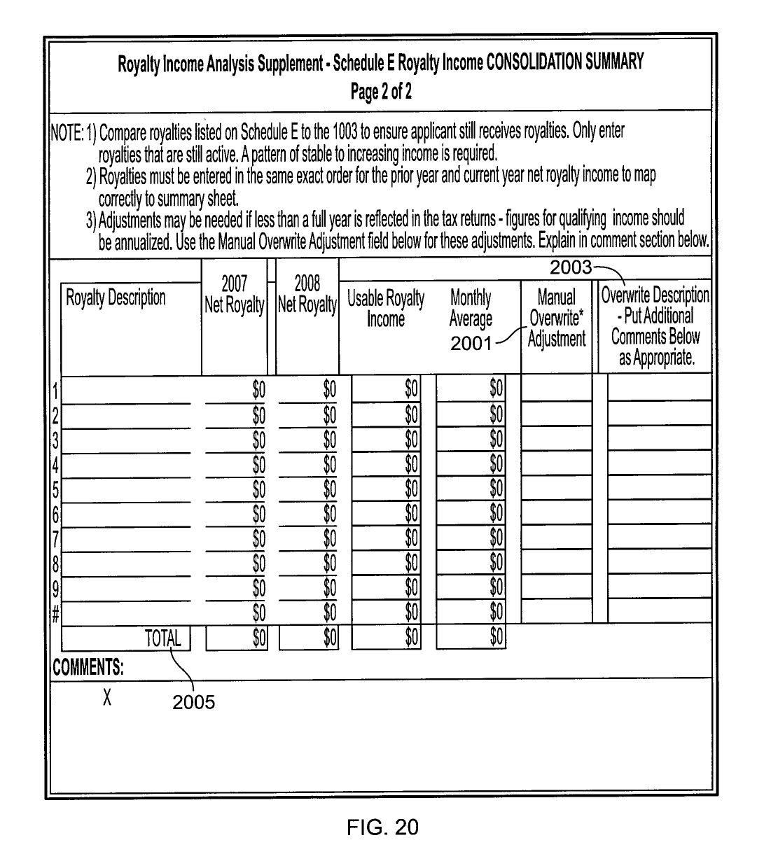

Proceeding to FIG. 20, one or more of the fields may be auto-populated by data entered in one or more of data fields 1901-1909 and 1951-1959. Column 2001 allows for an analyzing employee to enter an adjustment that manually overrides the data used for calculation purposes that was populated for a particular row from data entered in FIG. 19. Any of a number of reasons may exist for the allowance of an adjustment to the data by the analyzing employee based upon one or more policies and/or procedures of the loan offering entity. In each case, the system may be configured to require the entry of a comment, such as the justification for the adjustment, in a corresponding data field in column 2003. The system may not allow for the override without the inclusion of a justifiable entry in 2003. Having entered all of the needed data entries in the user interface, a resulting total royalties income 2005 may be generated. This resulting number may be the result of calculations taking into account the one or more adjustments entered in column 2001.

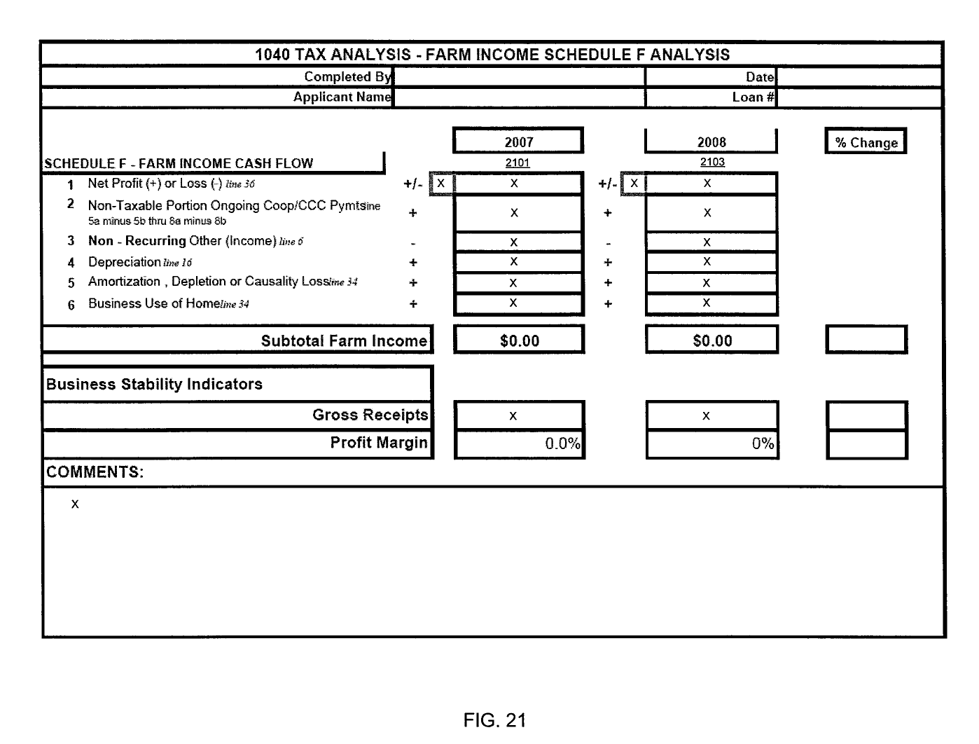

FIG. 21 is an illustrative user interface for receiving and processing tax data and alerting individuals of a needed correction and/or issue associated with the tax data in accordance with one or more aspects of the present disclosure. FIG. 21 illustrates an example schedule F form correlating to income from a farm business that an applicant/customer may have in the documentation she provided for receiving a loan. One or more data fields in columns 2101 and 2103 may be filled by an analyzing employee based upon documentation received from the applicant/customer and/or some other source. Data fields in columns 2101 correlate to data with respect to the year 2007 and data fields in column 2103 correlate to data with respect to the year 2008. Subtotal farm incomes for the respective years may be calculated and displayed to the analyzing employee.

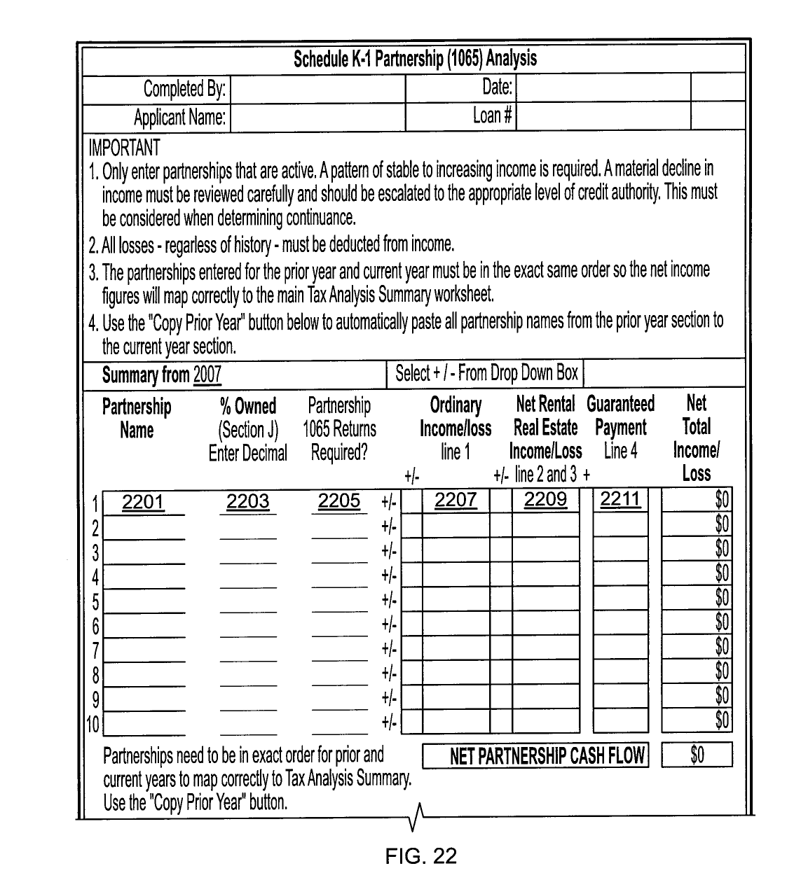

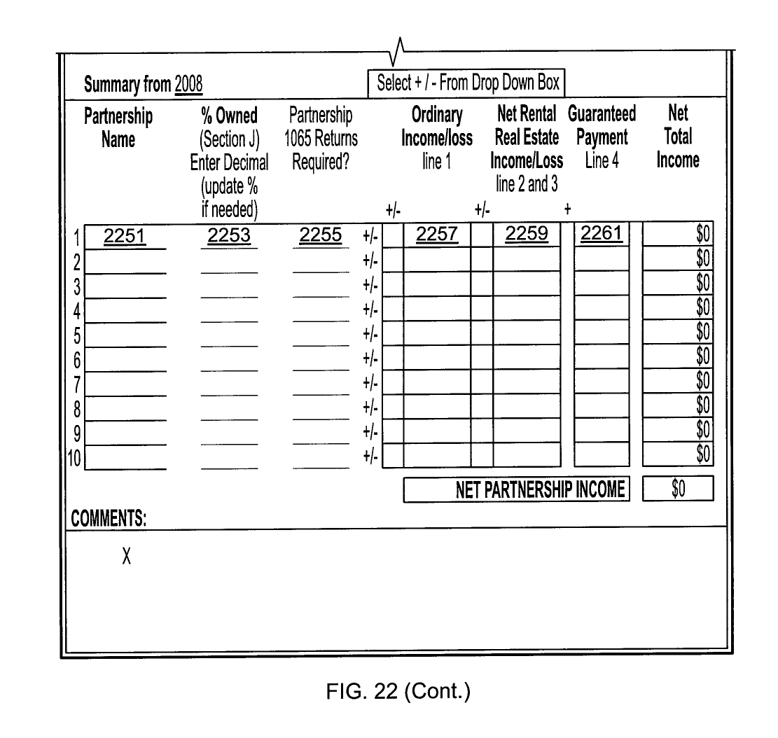

FIG. 22 is an illustrative user interface for receiving and processing tax data and alerting individuals of a needed correction and/or issue associated with the tax data in accordance with one or more aspects of the present disclosure. FIG. 22 illustrates an example schedule K-1 form correlating to partnerships income that an applicant/customer may have in the documentation she provided for receiving a loan. One or more data fields in columns 2201-2211 and 2251-2261 may be filled by an analyzing employee based upon documentation received from the applicant/customer and/or some other source. Data fields 2201-2211 correlate to data with respect to the year 2007 and data fields 2251-2261 correlate to data with respect to the year 2008. Net partnership cash flow for the respective years may be calculated and displayed to the analyzing employee. One or more schedule K-1 partnership forms may be provided as necessary to account for the different partnerships of the applicant/customer.

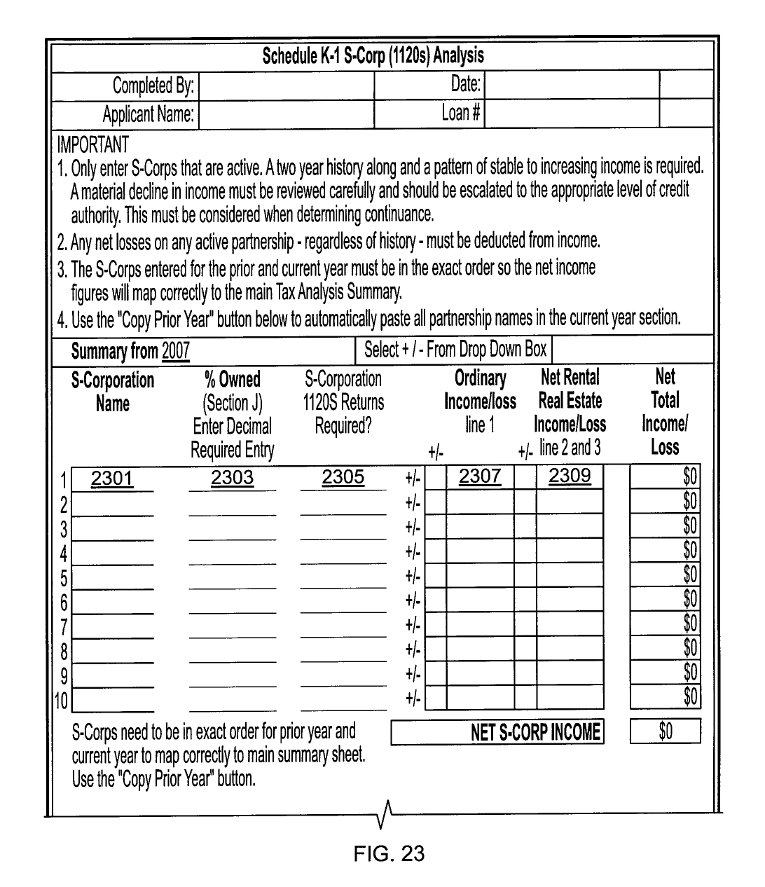

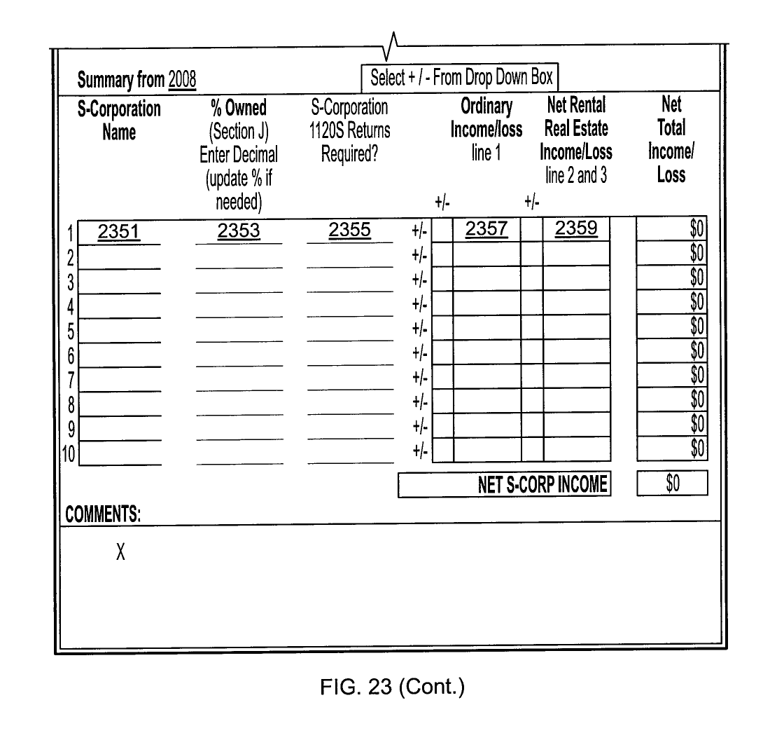

FIG. 23 is an illustrative user interface for receiving and processing tax data and alerting individuals of a needed correction and/or issue associated with the tax data in accordance with one or more aspects of the present disclosure. FIG. 23 illustrates an example schedule K-1 S-Corp form correlating to S-Corps income that an applicant/customer may have in the documentation she provided for receiving a loan. One or more data fields in columns 2301-2309 and 2351-2359 may be filled by an analyzing employee based upon documentation received from the applicant/customer and/or some other source. Data fields 2301-2309 correlate to data with respect to the year 2007 and data fields 2351-2359 correlate to data with respect to the year 2008. Net S-Corp income for the respective years may be calculated and displayed to the analyzing employee. One or more schedule K-1 S-Corp forms may be provided as necessary to account for the different S-Corps of the applicant/customer.

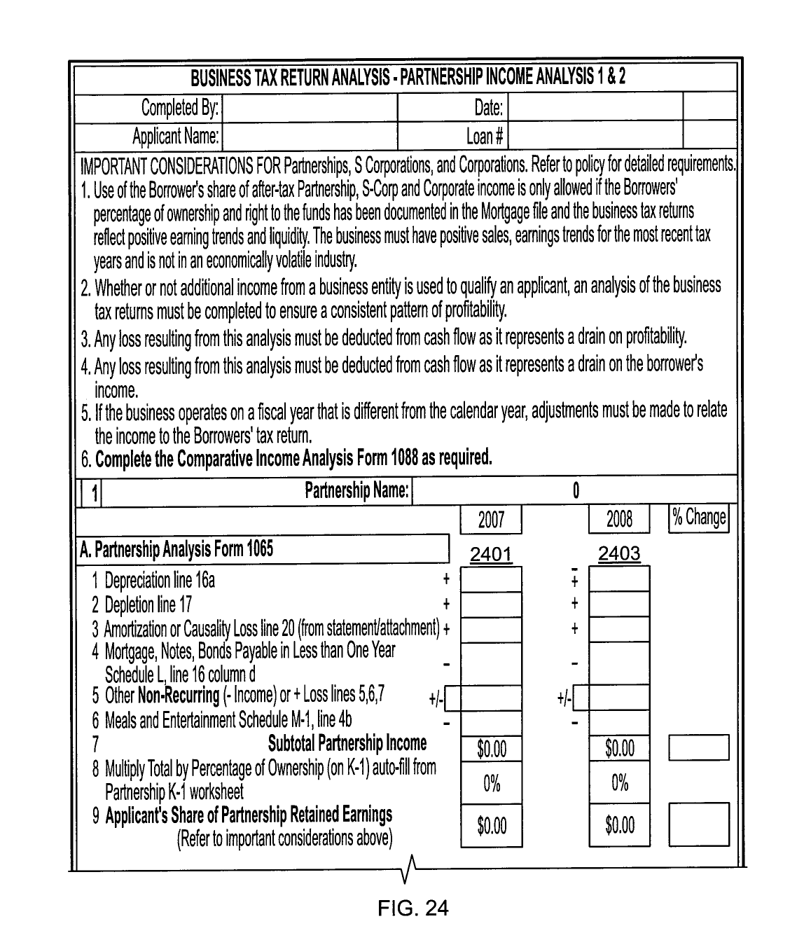

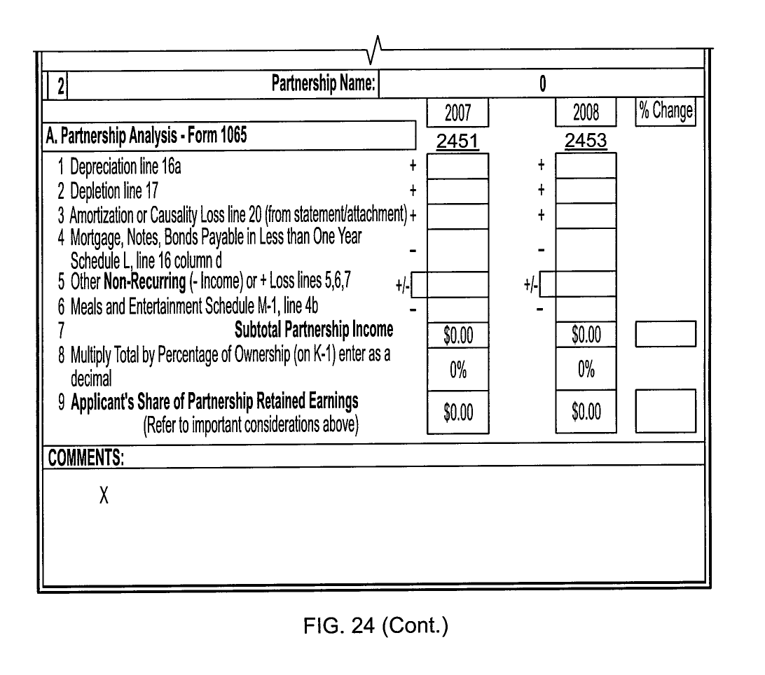

FIG. 24 is an illustrative user interface for receiving and processing tax data and alerting individuals of a needed correction and/or issue associated with the tax data in accordance with one or more aspects of the present disclosure. FIG. 24 illustrates an example partnership income analysis form correlating to one or more partnerships that an applicant/customer may have in the documentation she provided for receiving a loan. One or more data fields in columns 2401, 2451 and 2403, 2453 may be filled by an analyzing employee based upon documentation received from the applicant/customer and/or some other source. Data fields in column 2401 and 2451 correlate to data with respect to two different partnerships for the year 2007 and data fields in column 2403 and 2453 correlate data with respect to two different partnerships for the year 2008. Applicable partnership data for the respective years may be calculated and displayed to the analyzing employee. One or more additional partnership income analysis forms may be provided as necessary to account for the different partnerships of the applicant/customer.

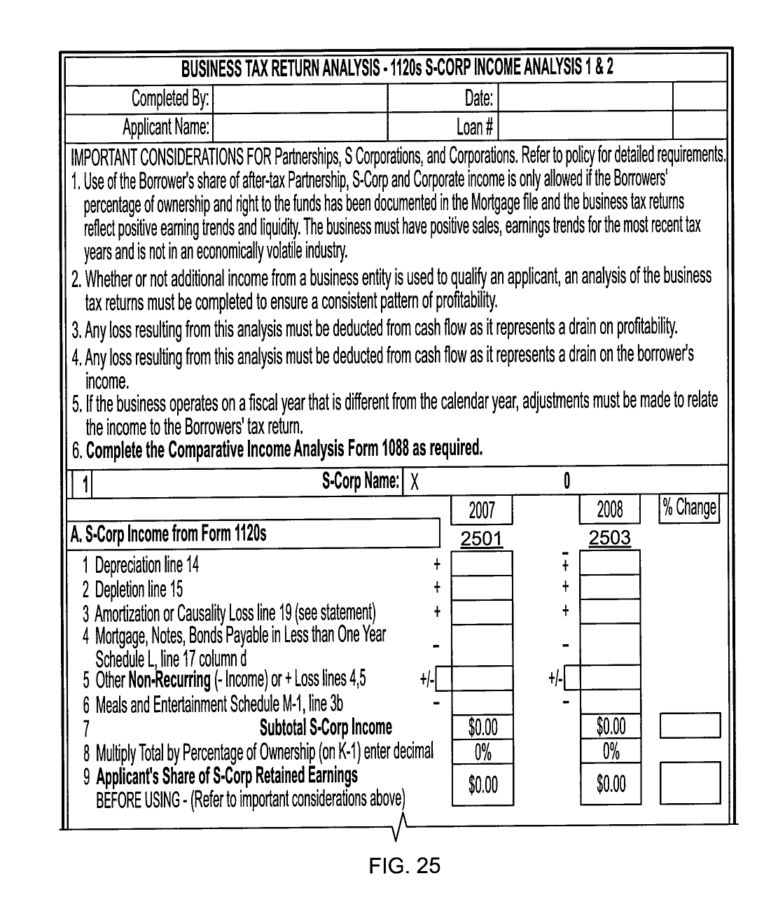

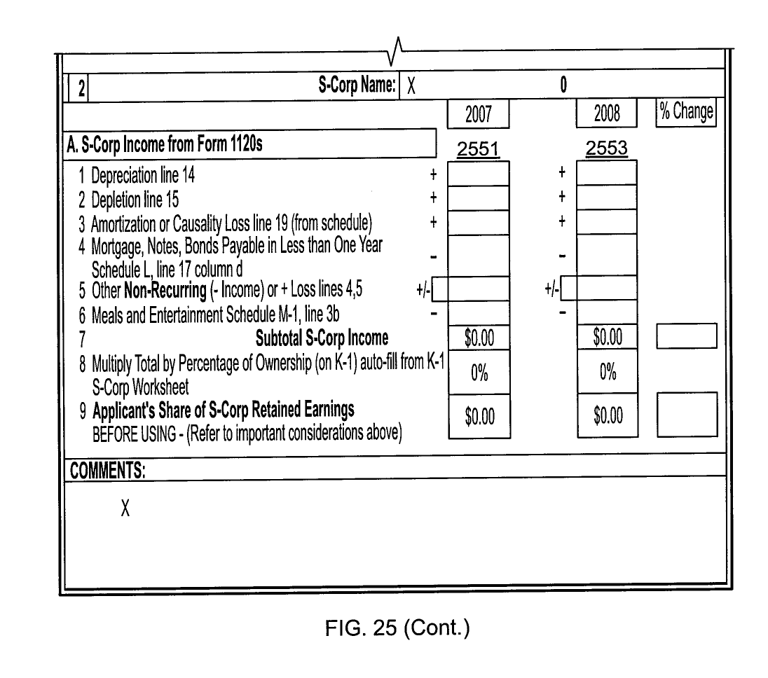

FIG. 25 is an illustrative user interface for receiving and processing tax data and alerting individuals of a needed correction and/or issue associated with the tax data in accordance with one or more aspects of the present disclosure. FIG. 25 illustrates an example S-Corp income analysis form correlating to one or more S-Corps that an applicant/customer may have in the documentation she provided for receiving a loan. One or more data fields in columns 2501, 2551 and 2503, 2553 may be filled by an analyzing employee based upon documentation received from the applicant/customer and/or some other source. Data fields in column 2501 and 2551 correlate to data with respect to two different S-Corps for the year 2007 and data fields in column 2503 and 2553 correlate data with respect to two different S-Corps for the year 2008. Applicable S-Corp data for the respective years may be calculated and displayed to the analyzing employee. One or more additional S-Corp income analysis forms may be provided as necessary to account for the different S-Corps of the applicant/customer.

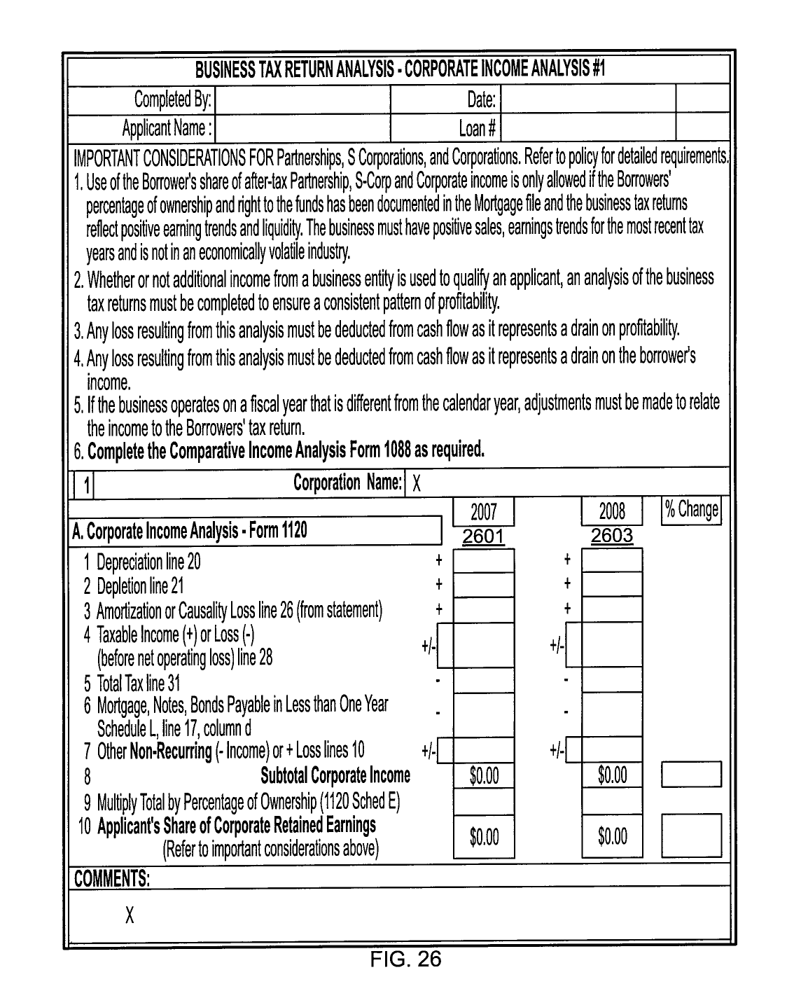

FIG. 26 is an illustrative user interface for receiving and processing tax data and alerting individuals of a needed correction and/or issue associated with the tax data in accordance with one or more aspects of the present disclosure. FIG. 26 illustrates an example corporate income analysis form correlating to one or more corporations that an applicant/customer may have in the documentation she provided for receiving a loan. One or more data fields in columns 2601 and 2603 may be filled by an analyzing employee based upon documentation received from the applicant/customer and/or some other source. Data fields in column 2601 correlate to data with respect to the year 2007 and data fields in column 2603 correlate to data with respect to the year 2008. Applicable corporate income data for the respective years may be calculated and displayed to the analyzing employee. One or more additional corporate income analysis forms may be provided as necessary to account for the different corporations of the applicant/customer.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present disclosure.

1. A method comprising:
processing, at a first computer, data representative of wage earnings of an applicant for a loan application to determine eligible base pay based upon one or more policies of a loan offering entity, the data representative of the wage earnings of the applicant based upon wage earnings data of the applicant associated with a personal 1040 form of the applicant;
outputting, from the first computer to an associated alert device, an alert representative of an issue in violation of the one or more policies of the loan offering entity; and
determining, at the first computer, whether to prevent further processing of a loan processing file representative of the loan application of the applicant until the alert is removed.

2. The method of claim 1, further comprising generating, at a second computer, the loan processing file representative of the loan application of the applicant.

3. The method of claim 2, wherein the first computer and the second computer are the same computer.

4. The method of claim 1, further comprising outputting, from the first computer to an associated display device, at least one user interface for entry of the data representative of the wage earnings of the applicant for the loan application.

5. The method of claim 4, further comprising receiving, at the first computer, the data representative of the wage earnings of the applicant for the loan application.

6. The method of claim 4, wherein the associated display device and the associated alert device are the same associated device.

7. The method of claim 1, further comprising generating, at the first computer, a final electronic file for the loan processing file representative of derivation of a personal cash flow amount for the applicant.

8. The method of claim 7, wherein the final electronic file further representative of derivation of a total business related income amount for the applicant.

9. The method of claim 1, wherein the data representative of the wage earnings of the applicant based upon rental property income earnings data of the applicant.

10. The method of claim 1, wherein the data representative of the wage earnings of the applicant based upon at least one of: sole proprietor income data of the applicant, royalty income data of the applicant, farm income data of the applicant, schedule K-1 partnership income data of the applicant, and schedule K-1 S-Corp income data of the applicant.

11. One or more computer readable media storing computer executable instructions that, when executed by at least one processor, cause the at least one processor to perform a method comprising:
processing, at a first computer, data representative of wage earnings of an applicant for a loan application to determine eligible base pay based upon one or more policies of a loan offering entity, the data representative of the wage earnings of the applicant based upon wage earnings data of the applicant associated with a personal 1040 form of the applicant;
outputting, from the first computer to an associated alert device, an alert representative of an issue in violation of the one or more policies of the loan offering entity; and
determining, at the first computer, whether to prevent further processing of a loan processing file representative of the loan application of the applicant until the alert is removed.

12. The one or more computer readable media of claim 11, the computer executable instructions further causing the at least one processor to perform generating, at a second computer, the loan processing file representative of the loan application of the applicant.

13. The one or more computer readable media of claim 11, the computer executable instructions further causing the at least one processor to perform outputting, from the first computer to an associated display device, at least one user interface for entry of the data representative of the wage earnings of the applicant for the loan application.

14. The one or more computer readable media of claim 11, the computer executable instructions further causing the at least one processor to perform generating, at the first computer, a final electronic file for the loan processing file representative of derivation of a qualified income amount for the applicant.

15. The one or more computer readable media of claim 14, wherein the final electronic file further representative of derivation of a total business related income amount for the applicant.

16. The one or more computer readable media of claim 11, the computer executable instructions further causing the at least one processor to perform, in response to determining, at the first computer, the alert is removed, processing, at the first computer, additional data representative of wage earnings of the applicant for the loan application.

17. The one or more computer readable media of claim 11, the computer executable instructions further causing the at least one processor to perform determining, at the first computer, a total business related income amount for the applicant.

18. The one or more computer readable media of claim 11, wherein the data representative of the wage earnings of the applicant based upon rental property income earnings data of the applicant.

19. The one or more computer readable media of claim 11, wherein the data representative of the wage earnings of the applicant based upon at least one of: sole proprietor income data of the applicant, royalty income data of the applicant, farm income data of the applicant, schedule K-1 partnership income data of the applicant, and schedule K-1 S-Corp income data of the applicant.

20. A method comprising:
generating, at a computer, a loan processing file representative of a loan application of an applicant;
outputting, from the computer to an associated display device, user interface for entry of data representative of wage earnings of the applicant, the data representative of the wage earnings of the applicant based upon wage earnings data of the applicant associated with a personal 1040 form of the applicant;
receiving, at the computer, the data representative of wage earnings of the applicant;
processing, at the computer, the data representative of the wage earnings of the applicant to determine eligible base pay based upon one or more policies of a loan offering entity;
outputting, from the computer to an associated alert device, an alert representative of an issue in violation of the one or more policies of the loan offering entity;
determining, at the computer, whether to prevent further processing of the loan processing file until the alert is removed; and
generating, at the computer, a final loan processing file representative of a personal cash flow amount for the applicant.
